(19) United States
(12) Patent Application Publication
(10) Pub. No.: US 2026/0359631 A1
(43) Pub. Date: Nov. 12, 2026

(54) TECHNIQUES FOR RUN-TIME MONITORING AND CONTROL OF GENERATIVE ARTIFICIAL INTELLIGENCE MODELS

(71) Applicant: Krnel Inc., New York, NY (US)

(72) Inventors: Peyman Faratin, New York, NY (US); Kimberly Jenney Wilber, Long Island City, NY (US)

(73) Assignee: Krnel Inc., New York, NY (US)

(21) Appl. No.: 19/670,505

(22) Filed: May 7, 2026

Related U.S. Application Data
(60) Provisional application No. 63/801,551, filed on May 7, 2025.

(51) Int. Cl. G06N 3/08

(52) U.S. Cl. CPC G06N 3/08

(57) ABSTRACT

A computer-implemented method for monitoring and controlling a generative artificial intelligence (AI) model is provided. The method includes selecting a layer of the AI model from which to obtain an intermediate activation result, receiving the intermediate activation result generated by the selected layer during processing of an input, and classifying the intermediate activation result utilizing a trained probe to determine a likelihood that the input and/or an output of the AI model violates a policy. A feedback result is generated based on the classification, and processing of the input by the AI model is modified by applying a control action based on the feedback result. The AI model can pause execution after generating the intermediate activation result and resume execution after receiving the feedback result. The AI model can operate within an agent harness.

### RELATED APPLICATIONS

This Application claims priority under 35 U.S.C. § 119(e) to U.S. Provisional Patent Application Ser. No. 63/801,551, filed May 7, 2025, entitled “SYSTEM AND METHOD FOR RUN-TIME SECURING OF ARTIFICIAL INTELLIGENCE SYSTEMS”, which is hereby incorporated by reference in its entirety.

### FIELD

The present disclosure relates to artificial intelligence systems, and more particularly to run-time monitoring and control of generative artificial intelligence models using intermediate activation results and trained probes.

### BACKGROUND

Generative artificial intelligence (AI) models, including large language models (LLMs) and image generation models, process input data through multiple layers of a neural network to generate outputs such as text, images, video, and other content. During processing, each layer of the neural network produces intermediate values, referred to as intermediate activation results, that represent the model's internal processing state at various stages of computation. Monitoring and controlling the behavior of these models during training and inference is important to prevent the generation of outputs that are harmful, misleading, or in violation of organizational policies, and to maintain trust, accountability, and compliance in AI deployment. As the deployment of generative AI models expands across enterprise, consumer-facing, and agentic applications, techniques for monitoring and controlling the behavior of these models and agents during inference continue to develop.

### SUMMARY

According to an aspect of the present disclosure, a system and method for run-time monitoring and control of generative artificial intelligence models using intermediate activation results and trained probes is provided.

In some embodiments, a computer-implemented method for monitoring and controlling a generative artificial intelligence (AI) model includes selecting a layer of the AI model from which to obtain an intermediate activation result, receiving the intermediate activation result generated by the selected layer during processing of an input, classifying, utilizing a trained probe, the intermediate activation result to determine a likelihood that the input and/or an output of the AI model violates a policy, generating, based on the classification, a feedback result, and modifying processing of the input by the AI model by applying a control action based on the feedback result.

In some embodiments, the AI model pauses execution after generating the intermediate activation result and resumes execution after receiving the feedback result, such that the control action affects generation of the output.

In some embodiments, the control action includes generating an altered intermediate activation result by altering one or more numerical values of the intermediate activation result based on activations associated with outputs that comply with the policy and activations associated with outputs that violate the policy, and providing the altered intermediate activation result to the AI model for continued processing.

In some embodiments, the control action includes halting transmission of the output to a device that originated the input.

In some embodiments, the control action includes altering a weight value associated with at least one neuron of the AI model.

In some embodiments, the control action includes pruning at least one neuron of the AI model.

In some embodiments, the trained probe includes a machine learning model.

In some embodiments, the machine learning model includes at least one of: a linear classifier, a sparse autoencoder, an independent component analysis model, a K-nearest-neighbor classifier, a support vector machine with linear kernels, a naïve Bayes model, a nearest centroid classifier, or a decision tree.

In some embodiments, the method further includes utilizing a plurality of trained probes to classify the intermediate activation result, wherein each trained probe of the plurality is associated with a weight, and generating the feedback result by combining outputs of the plurality of trained probes according to their respective weights.

In some embodiments, selecting the layer includes selecting a preselected group of layers of the AI model from which to receive intermediate activation results.

In some embodiments, the preselected group includes a first set of sequential layers from a beginning of the AI model and a second set of sequential layers from an end of the AI model.

In some embodiments, the method further includes preprocessing the intermediate activation result prior to the classifying, wherein preprocessing includes at least one of: whitening, mean subtraction, decorrelation, normalization, missing-data imputation, dimensionality reduction, or principal component analysis.

In some embodiments, the method further includes transferring the intermediate activation result from a first activation space to a second activation space utilizing a model that learns a transfer mapping between the first activation space and the second activation space, wherein the second activation space is smaller than the first activation space, and classifying a second intermediate activation result generated in the second activation space.

In some embodiments, classifying the intermediate activation result further includes receiving, as an auxiliary input to the trained probe, a routing state indicating a subset of expert sub-networks selected to process the input.

In some embodiments, the method further includes receiving a plurality of intermediate activation results over a sequence of processing steps, and aggregating outputs of the trained probe over a sliding window of the sequence to generate an aggregated result, wherein generating the feedback result is based on the aggregated result.

In some embodiments, the method further includes accumulating a cumulative sum of classification scores generated by the trained probe over the sequence of processing steps, and generating the feedback result when the cumulative sum exceeds a threshold.

In some embodiments, classifying includes computing a distance between the intermediate activation result and a mean of a distribution of activations associated with outputs that comply with the policy, the distance accounting for a covariance of the distribution, and determining the likelihood based on the distance.

In some embodiments, the method further includes maintaining a hidden Markov model with a plurality of latent states representing regimes of behavior of the AI model, inferring, from the outputs of the trained probe over the sequence, a posterior distribution over the latent states, and generating the feedback result based on the posterior distribution.

In some embodiments, the method further includes logging the intermediate activation result, the classification, and the control action.

In some embodiments, the method further includes retraining the trained probe based on the logged intermediate activation result and the logged classification.

In some embodiments, a system for monitoring and controlling a generative artificial intelligence (AI) model includes a processor and a memory storing instructions that, when executed by the processor, cause the processor to select a layer of the AI model from which to obtain an intermediate activation result, receive the intermediate activation result generated by the selected layer during processing of an input, classify, utilizing a trained probe, the intermediate activation result to determine a likelihood that the input and/or an output of the AI model violates a policy, generate, based on the classification, a feedback result, and modify processing of the input by the AI model by applying a control action based on the feedback result.

In some embodiments, the AI model pauses execution after generating the intermediate activation result and resumes execution after receiving the feedback result, such that the control action affects generation of the output.

In some embodiments, a non-transitory computer-readable medium stores instructions that, when executed by one or more processors, cause the one or more processors to select a layer of a generative artificial intelligence (AI) model from which to obtain an intermediate activation result, receive the intermediate activation result generated by the selected layer during processing of an input, classify, utilizing a trained probe, the intermediate activation result to determine a likelihood that the input and/or an output of the AI model violates a policy, generate, based on the classification, a feedback result, and modify processing of the input by the AI model by applying a control action based on the feedback result.

In some embodiments, the AI model pauses execution after generating the intermediate activation result and resumes execution after receiving the feedback result, such that the control action affects generation of the output.

In some embodiments, the AI model operates within an agent harness, and receiving the intermediate activation result includes receiving the intermediate activation result generated during the agent harness processing the input and/or the output by the AI model.

In some embodiments, the method further includes classifying, utilizing the trained probe, a second intermediate activation result generated after the agent harness modifies a context associated with the input to determine whether the policy is preserved in the modified context.

In some embodiments, a computer-implemented method for monitoring and controlling a closed generative artificial intelligence (AI) model includes intercepting, at a gateway, an input directed to the closed AI model, wherein internal weights of the closed AI model are not directly accessible, processing the input utilizing a second AI model to generate an intermediate activation result, wherein internal weights and intermediate activation results of the second AI model are directly accessible during processing of the input, classifying, utilizing a trained probe, the intermediate activation result to determine a likelihood that the input and/or an output of the closed AI model violates a policy, generating, based on the classification, a feedback result, and applying, based on the feedback result, a control action associated with processing of the input by the closed AI model.

In some embodiments, the gateway is positioned between an agent harness and the closed AI model, and intercepting the input includes receiving a request from the agent harness directed to the closed AI model prior to transmission to the closed AI model.

In some embodiments, the control action includes modifying the input prior to forwarding the input to the closed AI model.

In some embodiments, the control action includes modifying an output received from the closed AI model prior to forwarding the output.

In some embodiments, the second AI model is configured to generate the intermediate activation result that is discriminative for the classification.

In some embodiments, the gateway intercepts context data associated with the input, the context data including at least one of: the input, an output of the closed AI model, tool call data, or agent state data, and the second AI model generates the intermediate activation result based on the context data.

In some embodiments, the second AI model processes the input with a same prompt that is directed to the closed AI model, and the intermediate activation result is generated by a layer of the second AI model during processing of the prompt.

In some embodiments, the second AI model is trained based on input-output pairs collected from the closed AI model over time, such that the second AI model approximates a mapping between inputs and outputs of the closed AI model.

In some embodiments, the method further includes normalizing context data received from the gateway into a unified data model prior to processing the input utilizing the second AI model.

In some embodiments, the gateway includes agent-specific proxies, each proxy configured to intercept communications between a corresponding agent harness and the closed AI model.

In some embodiments, the trained probe is trained by collecting a first set of activations generated by the second AI model associated with outputs that comply with the policy, collecting a second set of activations generated by the second AI model associated with outputs that violate the policy, and training the trained probe to discriminate between the first set and the second set.

In some embodiments, the method further includes logging the context data intercepted by the gateway, the classification, and the control action.

In some embodiments, a system for monitoring and controlling a closed generative artificial intelligence (AI) model includes a processor and a memory storing instructions that, when executed by the processor, cause the processor to intercept, at a gateway, an input directed to the closed AI model, wherein internal weights of the closed AI model are not directly accessible, process the input utilizing a second AI model to generate an intermediate activation result, wherein internal weights and intermediate activation results of the second AI model are directly accessible during processing of the input, classify, utilizing a trained probe, the intermediate activation result to determine a likelihood that the input and/or an output of the closed AI model violates a policy, generate, based on the classification, a feedback result, and apply, based on the feedback result, a control action associated with processing of the input by the closed AI model.

In some embodiments, the system further includes normalizing context data intercepted by the gateway into a unified data model prior to processing the input utilizing the second AI model.

In some embodiments, a non-transitory computer-readable medium stores instructions that, when executed by one or more processors, cause the one or more processors to intercept, at a gateway, an input directed to a closed generative artificial intelligence (AI) model, wherein internal weights of the closed AI model are not directly accessible, process the input utilizing a second AI model to generate an intermediate activation result, wherein internal weights and intermediate activation results of the second AI model are directly accessible during processing of the input, classify, utilizing a trained probe, the intermediate activation result to determine a likelihood that the input and/or an output of the closed AI model violates a policy, generate, based on the classification, a feedback result, and apply, based on the feedback result, a control action associated with processing of the input by the closed AI model.

The foregoing apparatus and method embodiments may be implemented with any suitable combination of embodiments, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 illustrates a block diagram of an open AI system environment configured for monitoring and controlling AI model operations, according to some embodiments of the technology described herein.

FIG. 2 illustrates a flowchart of a method for monitoring and controlling an AI model during processing of an input (e.g., AI model monitor and control system of FIG. 1), according to some embodiments of the technology described herein.

FIG. 3 illustrates a block diagram of a closed AI system environment configured for monitoring and controlling AI model operations through a gateway, according to some embodiments of the technology described herein.

FIG. 4 illustrates a block diagram of an AI model (e.g., the AI model(s) of FIG. 1) processing an input to generate an output, according to some embodiments of the technology described herein.

FIG. 5 illustrates a block diagram of a classification module (e.g., the classification module of FIG. 1) during training, according to some embodiments of the technology described herein.

FIG. 6 illustrates a flowchart of a method for training a software probe for an AI model monitoring system (e.g., the AI model monitor and control system of FIG. 1 and/or FIG. 3), according to some embodiments of the technology described herein.

FIG. 7 illustrates a block diagram of a system for monitoring and classifying intermediate activation results from an AI system during runtime, according to some embodiments of the technology described herein.

FIG. 8 illustrates a flowchart of a method for monitoring and controlling a closed AI model through a gateway (e.g., using the AI model monitor and control system of FIG. 3), according to some embodiments of the technology described herein.

FIG. 9 illustrates a block diagram of a computing device (e.g., configured to implement the AI model monitor and control system of FIG. 1 and/or FIG. 3), according to some embodiments of the technology described herein.

### DETAILED DESCRIPTION

The present disclosure generally provides techniques for run-time monitoring, detection, and control of generative artificial intelligence (AI) models. More particularly, the techniques involve monitoring intermediate activation results generated by layers of a generative AI model during processing of an input, classifying the intermediate activation results using trained probes to determine a likelihood that the input and/or an output of the AI model violates a policy, and modifying processing of the input by the AI model by applying a control action based on the classification.

Generative AI models, including large language models (LLMs) and image generation models, are increasingly deployed in enterprise, consumer-facing, and agentic applications where the inputs and outputs of these multimodal models can have significant consequences. For example, a generative AI model deployed in a healthcare application may generate a response that discloses sensitive patient information, or a generative AI model deployed in a financial services application may generate a recommendation that violates regulatory requirements. The inventors have recognized that conventional approaches to monitoring and controlling the inputs and outputs of generative AI models face several technological challenges.

Conventional approaches for monitoring generative AI model inputs and outputs often rely on pre-processing and post-processing moderation systems that evaluate content before or after the AI model has fully processed the input and produced a final output. These pre-processing and post-processing systems apply predefined rules or learned classifiers to the input and/or the final output to flag or suppress content that is toxic, biased, or otherwise not compliant with a domain policy. However, the inventors have recognized that pre-processing and post-processing moderation is susceptible to evasion because adversaries can subtly manipulate prompts to generate outputs that circumvent moderation boundaries. Additionally, reliance on static rules applied to inputs and final outputs often leads to over-blocking benign content or under-filtering nuanced harm, particularly in multi-turn dialogues and multi-step agentic workflows where individual inputs and outputs may appear compliant in isolation but become non-compliant when considered in aggregate.

The inventors have further recognized that conventional approaches lack the ability to observe and act upon the internal processing state of the AI model during inference, before the output is generated. This limitation prevents early detection of inputs or outputs that may violate organizational policies and prevents intervention during the model's processing pipeline where corrective action can be applied with lower computational cost and higher effectiveness.

The inventors have developed technology that overcomes these technological challenges by monitoring intermediate activation results generated by layers of a generative AI model during processing, rather than waiting for the AI model to produce a final output. An intermediate activation result can refer to numerical values generated by a layer of the AI model during a forward pass through the model's neural network. The intermediate activation result represents the AI model's internal processing state at a particular stage of computation and is not utilized as an output of the AI model, but instead to reason, plan, and produce the output. By monitoring these intermediate activation results, the technology can detect patterns indicative of internal and externals states of the AI model that may violate a policy before the output is fully generated, and can apply control actions to modify the AI model's state and processing in real time.

A policy can refer to any rule, constraint, guideline, or requirement that specifies acceptable or unacceptable behavior of a generative AI model. A policy can include, for example, organizational security policies that restrict the generation of content containing sensitive information, safety policies that prevent the generation of harmful or toxic content, compliance requirements such as HIPAA or GDPR regulations that govern the handling of personal data, bias mitigation policies that prevent the generation of discriminatory content, and/or reliability policies that ensure the accuracy and consistency of generated outputs. A policy can also include domain-specific constraints, among other concepts, such as financial regulations governing investment recommendations, healthcare regulations governing medical advice, and/or legal regulations governing the generation of legal opinions. In some embodiments, a policy may be ingested from unstructured or structured policy specifications, preprocessed and normalized, disambiguated to resolve ambiguities, and transformed into a structured representation compatible with neural operations, enabling version control and auditability. In some embodiments, training examples that exemplify compliance and non-compliance with the policy may be synthesized or curated to map abstract policy rules to the target model's internal representation space.

A trained probe can refer to a software module that includes a machine learning model trained to classify intermediate activation results. A trained probe can include, for example, a linear classifier, a sparse autoencoder (SAE), an independent component analysis (ICA) model, a K-nearest-neighbor classifier, a support vector machine with linear kernels, a naïve Bayes model, a nearest centroid classifier, a decision tree, or any suitable combination thereof. A trained probe can also include a machine learning model utilizing a radial basis function kernel, a polynomial kernel, a non-linear kernel, or any suitable combination thereof. A trained probe can be trained to discriminate between activations associated with outputs that comply with a policy and activations associated with outputs that violate the policy. A trained probe requires less computation in classification than processing all layers of the AI model, enabling real-time monitoring with minimal latency overhead.

A control action can refer to any action taken to modify processing of an input and/or an output by the AI model based on a feedback result generated by the classification. A control action can include, for example, altering one or more numerical values of the intermediate activation result and providing the altered intermediate activation result to the AI model for continued processing, altering a weight value associated with at least one neuron of the AI model (temporarily or permanently), pruning at least one neuron of the AI model, re-prompting the AI model, and/or halting transmission of the output to a device that originated the input. A control action can also include logging the classification and the control action for observability purposes, and/or retraining the trained probe based on logged data.

The technology developed by the inventors overcomes the technological challenge of conventional pre-processing and post-processing approaches by enabling monitoring and control during the AI model's inference, rather than after an output is generated. The technology selects a layer of the AI model from which to obtain an intermediate activation result, receives the intermediate activation result generated by the selected layer during processing of an input, classifies the intermediate activation result using a trained probe to determine a likelihood that the input and/or an output of the AI model is considering and likely violates a policy, generates a feedback result based on the classification, and modifies processing of the input by the AI model by applying a control action based on the feedback result. In some embodiments, the AI model pauses execution after generating the intermediate activation result and resumes execution after receiving the feedback result, such that the control action affects generation of the output. This pause-and-resume execution flow enables the technology to intervene during the same forward pass in which the intermediate activation result was generated, rather than requiring a separate post-processing pass over the final output.

The techniques described herein provide technological improvements in monitoring and control of generative AI models through the intermediate activation monitoring approach. The intermediate activation monitoring approach enables detection of inputs and outputs that may violate a policy before the output is fully generated, reducing the computational cost of remediation by intervening at an earlier stage of processing. The trained probe approach enables classification with lower computational overhead than processing all layers of the AI model, enabling real-time monitoring with approximately no additional token of latency per turn. The control action approach enables modification of the AI model's processing in real time, including altering intermediate activation results, altering weight values, pruning neurons, re-prompting the AI model, and/or halting output transmission, providing a range of intervention mechanisms that can be selected based on the severity and nature of the detected policy violation. In some embodiments, the technology can be deployed in a hooked operation mode where the AI model is directly accessible and intermediate activation results are obtained from the AI model's hidden layers, or in a digital twin operation mode where the AI model is not directly accessible and intermediate activation results are obtained from another accessible model operating in its own activation space.

By way of example, a generative AI model deployed in an enterprise application may receive an input prompt from a user. The technology selects a module of the AI model, such as a residual stream at a module selected to maximize classification performance, and receives the intermediate activation result generated by the selected module during processing of the input. The technology classifies the intermediate activation result using a trained probe, such as a linear classifier trained to discriminate between activations associated with policy-compliant outputs and activations associated with policy-violating outputs. If the classification indicates a likelihood that the AI model will generate an output that violates the organization's security policy, the technology generates a feedback result and applies a control action, such as altering one or more numerical values of the intermediate activation result based on a difference computed between a first set of activations associated with policy-compliant outputs and a second set of activations associated with policy-violating outputs, and providing the altered intermediate activation result to the AI model for continued processing. The AI model resumes execution with the altered intermediate activation result and generates an output that complies with the organization's security policy as it applies to the enterprise application.

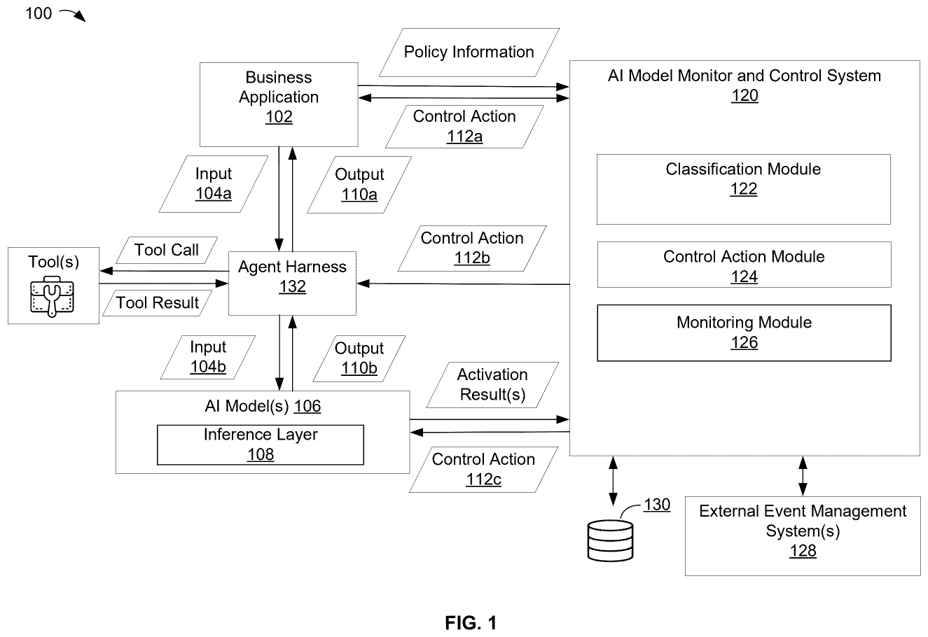

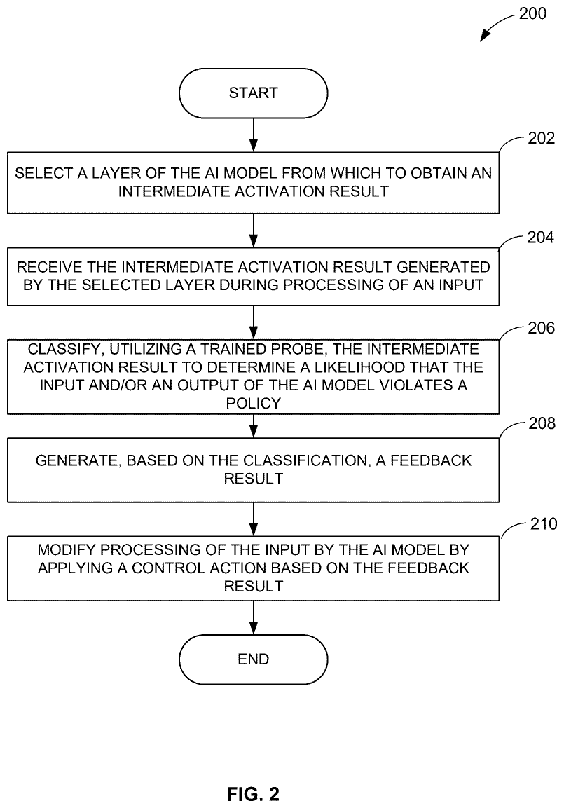

Accordingly, some embodiments provide for a computer-implemented method (e.g., the method 200 of FIG. 2) for monitoring, detecting, and controlling a generative artificial intelligence (AI) model (e.g., the AI model(s) 106 of FIG. 1). The method includes selecting a layer of the AI model from which to obtain an intermediate activation result, receiving the intermediate activation result generated by the selected layer during processing of an input (e.g., the input 104a or 104b of FIG. 1), classifying, utilizing a trained probe (e.g., the classification module 122 of FIG. 1), the intermediate activation result to determine a likelihood that the input and/or an output (e.g., the output 110a or 110b of FIG. 1) of the AI model violates a policy, generating, based on the classification, a feedback result, and modifying processing of the input by the AI model by applying a control action (e.g., the control action 112a, 112b, or 112c of FIG. 1) based on the feedback result.

Following below are more detailed descriptions of various concepts related to, and embodiments of, techniques for monitoring and controlling generative artificial intelligence models using intermediate activation results and trained probes. Examples of details of implementation are provided herein solely for illustrative purposes. It should be appreciated that various aspects described herein may be implemented in any of numerous ways. In addition, the various aspects described in the embodiments below may be used alone or in any combinations and are not limited to the combinations explicitly described herein.

FIG. 1 illustrates a block diagram of an open AI system environment 100 configured for monitoring and controlling AI model operations, according to some embodiments of the technology described herein. Referring to FIG. 1, the open AI system environment 100 (also referred to as “environment 100”) can be configured to enable run-time monitoring and control of one or more generative AI models during processing of an input. The environment 100 is referred to as “open” because the AI model(s) 106 are directly accessible, meaning the internal weights, layers, and intermediate activation results of the AI model(s) 106 can be observed and modified during processing. As illustrated, the environment 100 includes a business application 102, an agent harness 132, AI model(s) 106, an inference layer 108, and an AI model monitor and control system 120 (also referred to as “monitor and control system 120”).

In operation, the business application 102 sends an input 104a to the agent harness 132, which processes the input and sends an input 104b to the AI model(s) 106. The AI model(s) 106 processes the input 104b through a plurality of layers, including the inference layer 108, to generate an output 110b. The output 110b is returned to the agent harness 132, which processes the output and sends an output 110a to the business application 102. During processing, the inference layer 108 generates intermediate activation results at one or more layers of the AI model(s) 106 and provides the intermediate activation results to the monitor and control system 120. The monitor and control system 120 classifies the intermediate activation results using trained probes to determine a likelihood that the input violates a policy and/or the AI model(s) 106 will generate an output that violates a policy, and applies a control action to modify processing of the input 104a or 104b by the AI model(s) 106 based on the classification. Each component of the environment 100 will be described in turn.

As shown in FIG. 1, the business application 102 can be configured to send the input 104a to the agent harness 132 and to receive the output 110a from the agent harness 132. The business application 102 can represent any software application, service, or system that utilizes the AI model(s) 106 through the agent harness 132 to process inputs and generate outputs. For example, the business application 102 can include a customer-facing application that sends user queries to the AI model(s) 106 and returns generated responses, an internal enterprise tool that processes documents or data using the AI model(s) 106, a software development environment that utilizes the AI model(s) 106 for code generation, or any other suitable application that consumes AI model outputs.

In some embodiments, the agent harness 132 can be configured to make tool calls to external tools and databases that store and manage data utilized by the AI model(s) 106 during processing. The business application 102 can communicate with the agent harness 132 and/or the monitor and control system 120 using any suitable communication protocol, such as Model Context Protocol (MCP), Hypertext Transfer Protocol (HTTP), or any suitable combination thereof. In some embodiments, the business application 102 can include business logic that specifies how inputs are constructed, how outputs are consumed, and what policies govern the acceptable behavior of the AI model(s) 106. The business application 102 can be configured to provide policy information to the monitor and control system 120, where the policy information specifies rules, constraints, and/or requirements that the output 110 of the AI model(s) 106 is expected to satisfy.

In some embodiments, the business application 102 can be configured to receive a control action 112a from the monitor and control system 120. The control action 112a can include, for example, an instruction to halt delivery of the output 110a to a user or device that originated the input 104a, an instruction to modify the output 110a before delivery, a notification that the AI model(s) 106 generated or is likely to generate an output that violates a policy, and/or any other suitable action. The monitor and control system 120 sits between the business application 102, the agent harness 132, and the AI model(s) 106, enabling the monitor and control system 120 to observe and modify the behavior of the agent harness and/or AI model(s) 106 before the output 110a is delivered to the business application 102.

In some embodiments, the agent harness 132 can be configured to receive a control action 112b from the monitor and control system 120. The control action 112b can include, for example, an instruction to not execute a tool call that is about to be invoked by the agent harness 132, an instruction to modify the input 104b before forwarding to the AI model(s) 106, or an instruction to modify the output 110b before returning to the business application 102. In some embodiments, the control action 112b can include re-prompting the AI model(s) 106 with a modified input.

In some embodiments, the input processed by the AI model(s) 106 can include a direct input and an agent-generated input. The direct input can correspond to the input 104a originating from a user or external system through the business application 102. The agent-generated input can correspond to the input 104b, which can include context assembled by the agent harness 132 from prior iterations of the reasoning loop, such as tool results, retrieved documents, memory reads, compacted context, the AI model's own prior outputs, and system instructions injected by the agent harness 132. The classification module 122 can be configured to classify intermediate activation results to determine a likelihood that the direct input and/or the agent-generated input violates a policy. For example, classifying intermediate activation results based on the direct input can enable detection of prompt injection attacks in which an adversary manipulates the user input to elicit policy-violating behavior, and classifying intermediate activation results based on the agent-generated input can enable detection of reliability issues in long-running agents, such as goal drift, policy loss during context compaction, or accumulation of misleading context across iterations.

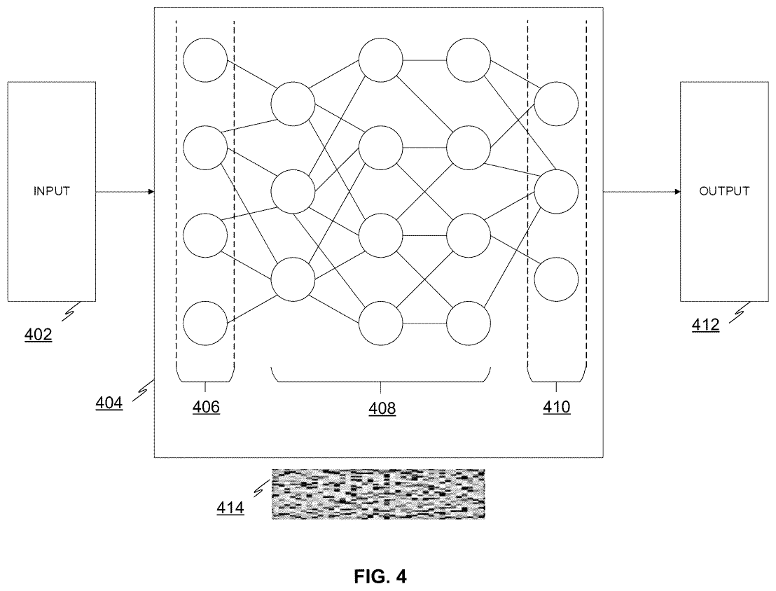

As shown in FIG. 1, the AI model(s) 106 can include one or more generative AI models configured to process the input 104b and generate the output 110b. In some embodiments, the AI model(s) 106 can include a large language model (LLM), an image generation model, a video generation model, or any suitable combination thereof. In some embodiments, the AI model(s) 106 can include a neural network having an input layer, a plurality of hidden layers, and an output layer, as described in further detail with respect to FIG. 4. Each layer of the AI model(s) 106 includes a plurality of neurons that apply weighted sums and non-linear activation functions to inputs from the previous layer. During processing of the input 104b, one or more layers of the AI model(s) 106 generate intermediate activation results that represent the AI model's internal processing state at various stages of computation. The intermediate activation results are not utilized as the output 110b of the AI model(s) 106, but instead are utilized by the AI model(s) 106 to produce the output 110b.

As shown in FIG. 1, the inference layer 108 can be a component within the AI model(s) 106 that performs inference by processing the input 104b through the layers of the AI model(s) 106 to produce the output 110b. In some embodiments, the inference layer 108 can be configured to generate intermediate activation results at one or more layers during processing, including at a reasoning point where the AI model(s) 106 reason, plan, and form intent, and to provide the intermediate activation results to the monitor and control system 120. In some embodiments, the inference layer 108 can be configured to receive a control action 112c from the monitor and control system 120 and to apply the control action 112c to modify processing of the input 104b by the AI model(s) 106. For example, the control action 112c can include an altered intermediate activation result that is provided back to the AI model(s) 106 for continued processing. In other embodiments the control action 112c can be to re-prompt the AI model(s). In some embodiments, the AI model(s) 106 can be configured to pause execution after generating an intermediate activation result and resume execution after receiving the control action 112c from the monitor and control system 120, such that the control action 112c affects generation of the output 110b.

As shown in FIG. 1, the monitor and control system 120 can be configured to monitor, classify, and control the operation of the AI model(s) 106 during processing of the input 104a or 104b. The monitor and control system 120 includes a classification module 122, a control action module 124, and a monitoring module 126. For example, when the business application 102 sends an input 104a requesting the AI model(s) 106 to generate a response to a user query, the monitor and control system 120 can receive intermediate activation results from the inference layer 108 during processing, classify the intermediate activation results to determine whether the input and/or an output of the AI model(s) 106 violates an organizational security policy, and apply a control action to alter the intermediate activation results before the AI model(s) 106 produces the final output 110b. The monitoring module 126 can log the intermediate activation results, the classification results, and the control actions for observability purposes.

In some embodiments, the classification module 122 can be configured to receive policy information from the business application 102 that specifies the rules, constraints, and requirements governing the acceptable behavior of the AI model(s) 106. The policy information can be utilized to train the trained probes of the classification module 122, such that the trained probes learn to discriminate between intermediate activation results associated with outputs that comply with the policy and intermediate activation results associated with outputs that violate the policy. For example, the classification module 122 can collect a first set of activations associated with outputs that comply with the policy and a second set of activations associated with outputs that violate the policy, and train the trained probes to discriminate between the first set and the second set. In some embodiments, the policy information can be ingested from unstructured or structured policy specifications, preprocessed and normalized, disambiguated to resolve ambiguities, and transformed into a structured representation compatible with neural operations, enabling version control and auditability. Training examples that exemplify compliance and non-compliance with the policy can be synthesized or curated to map abstract policy rules to the target model's internal representation space.

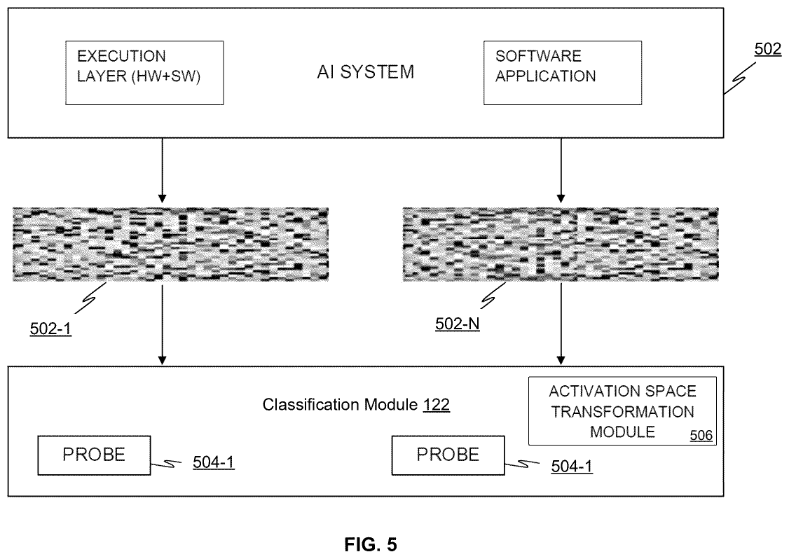

In some embodiments, the classification module 122 can be configured to receive intermediate activation results from the AI model(s) 106 through the inference layer 108 and to classify the intermediate activation results using one or more trained probes. The classification module 122 is described in further detail with respect to FIG. 5. A trained probe can include a machine learning model, such as a linear classifier, a sparse autoencoder (SAE), an independent component analysis (ICA) model, a K-nearest-neighbor classifier, a support vector machine with linear kernels, a naïve Bayes model, a nearest centroid classifier, a decision tree, or any suitable combination thereof. In some embodiments, the classification module 122 can be configured to classify the intermediate activation results to determine a likelihood that the input and/or an output of the AI model(s) 106 violates a policy. In some embodiments, the classification module 122 can be configured to utilize a plurality of trained probes to classify the intermediate activation results, wherein each trained probe is associated with a weight, and the classification module 122 generates a feedback result by combining outputs of the plurality of trained probes according to their respective weights. In some embodiments, the classification module 122 can include an activation space transformation module that maps activations from other activation spaces, including activations from another AI model, to a standardized activation space that is then used by the trained probes. The activation space transformation module is described in further detail with respect to FIG. 5.

In some embodiments, the classification module 122 can be configured to select a layer of the AI model(s) 106 from which to obtain an intermediate activation result. The selection of which layer to monitor can affect the quality of the classification, as different layers of the AI model(s) 106 encode different levels of abstraction of the input 104a and/or 104b. Earlier layers may encode lower-level features such as token-level syntax, while later layers may encode higher-level features such as semantic intent and policy-relevant concepts. The classification module 122 can be configured to evaluate multiple candidate layers and select the layer or layers whose intermediate activation results are most informative for the classification task.

In some embodiments, selecting the layer can include selecting a preselected group of layers of the AI model(s) 106 from which to receive intermediate activation results. For example, the preselected group can include a first set of sequential layers from a beginning of the AI model(s) 106 and a second set of sequential layers from an end of the AI model(s) 106. As another example, the preselected group can include every Nth layer of the AI model(s) 106, non-adjacent layers selected based on empirical performance, or any suitable combination thereof.

In some embodiments, the layer can be selected based on a compression-based criterion, such as a minimum description length (MDL) criterion, that identifies layers whose representations are most informative for the classification task. The MDL criterion can evaluate each candidate layer by measuring how efficiently a simple decoder can compress the classification labels given the layer's representations. A layer at which the labels can be encoded with fewer bits indicates that the layer's representations contain more information relevant to the classification task. In some embodiments, the layer can be selected from a module of the AI model(s) 106, such as residual stream of the AI model(s) 106 at a position selected to maximize classification performance. For example, the classification module 122 can evaluate classification accuracy at each candidate layer on a held-out validation set and select the layer that achieves the highest accuracy.

In some embodiments, the classification module 122 can be configured to preprocess the intermediate activation result prior to classification. Preprocessing can transform the intermediate activation result into a standardized form that is more suitable for classification by the trained probes. Preprocessing can include whitening, mean subtraction, decorrelation, normalization, missing-data imputation, dimensionality reduction, principal component analysis, or any suitable combination thereof. For example, whitening can transform the intermediate activation result such that its components have unit variance and are uncorrelated, which can improve the performance of linear classifiers by removing redundant correlations in the activation data.

In some embodiments, the classification module 122 can be configured to transfer the intermediate activation result from a first activation space to a second activation space utilizing a transfer-learned model, wherein the second activation space is smaller and standardized relative to the first activation space. The transfer-learned model can be configured to project the intermediate activation result into a lower-dimensional space that preserves the information relevant to the classification task while discarding information that is not relevant. The classification module 122 can then classify a second intermediate activation result generated in the second activation space. For example, an intermediate activation result having a dimensionality of several thousand values can be projected into a second activation space having a dimensionality of several hundred values, reducing the computational cost of classification while preserving the discriminative signal.

In some embodiments, the classification module 122 can be configured to receive a plurality of intermediate activation results over a sequence of processing steps and to aggregate outputs of the trained probes over a sliding window of the sequence to generate an aggregated result. The sliding window can have a configurable size N, and the aggregated result can be computed as an average, a weighted average, or an exponentially-weighted moving average of the probe outputs within the window. Aggregating probe outputs over a sliding window can reduce variance caused by per-position fluctuations in the intermediate activation results while preserving slowly-varying signals that are indicative of policy-relevant behavior. For example, a single intermediate activation result at one position in the sequence may produce a noisy classification score, but averaging the classification scores over a window of 10 consecutive positions can produce a more stable and reliable estimate of the likelihood that the input violates the policy and/or the AI model(s) 106 will generate an output that violates the policy.

In some embodiments, the classification module 122 can be configured to accumulate a cumulative sum of classification scores generated by the trained probes over the sequence of processing steps and to generate the feedback result when the cumulative sum exceeds a threshold. The cumulative sum can be computed as a running accumulator that adds each new classification score and subtracts a baseline value, resetting to zero when the accumulator becomes negative. This approach can detect persistent small shifts in the classification scores that no individual classification score would reveal, enabling the classification module 122 to detect gradual transitions toward policy-violating behavior. For example, a sequence of classification scores that are individually below a per-step detection threshold but collectively indicate a sustained drift toward policy-violating behavior can be detected by the cumulative sum exceeding a calibrated threshold.

In some embodiments, the classification module 122 can be configured to decompose the probe output at each processing step into latent components using a state-space model, such as a Kalman filter. The state-space model can separate the probe output into a slowly-evolving intent component, a context-bias component, and per-position noise, producing estimates of each component separately with per-step uncertainty. The Kalman filter can compute a posterior mean and covariance in constant time per step, enabling real-time decomposition during inference. In some embodiments, nonlinear generalizations such as an extended Kalman filter, an unscented Kalman filter, or a particle filter can be utilized where linear-Gaussian assumptions are inadequate. The uncertainty bounds produced by the state-space model can enable the control action module 124 to condition control actions on confidence, not only on magnitude.

In some embodiments, the classification module 122 can be configured to apply a Savitzky-Golay filter to the sequence of probe outputs. The Savitzky-Golay filter can fit a local polynomial to a sliding window of probe outputs and return the polynomial value at the center of the window, preserving sharp transitions in the probe output better than a uniform moving average at comparable noise reduction. The filter coefficients can be derived in closed form from a least-squares polynomial fit and can be applied in constant time per step.

In some embodiments, the classification module 122 can be configured to maintain a hidden Markov model with a plurality of latent states representing regimes of behavior of the AI model(s) 106. The latent states can represent, for example, a benign regime, a planning regime, and a crystallized regime, where transitions between regimes indicate changes in the AI model's intent. The classification module 122 can infer, from the outputs of the trained probes over the sequence, a posterior distribution over the latent states, and generate the feedback result based on the posterior distribution. For example, when the posterior probability of the crystallized regime exceeds a threshold, the classification module 122 can generate a feedback result indicating that the AI model(s) 106 is likely to generate an output that violates the policy.

In some embodiments, the classification module 122 can be configured to compute a distance between the intermediate activation result and a mean of a distribution of activations associated with outputs that comply with the policy, the distance accounting for a covariance of the distribution. The distance can be computed as a Mahalanobis distance or a Hotelling T-squared statistic, which accounts for the covariance structure of the benign activation distribution and flags intermediate activation results that deviate along low-variance directions where rare but meaningful signals are most likely to appear. For example, an intermediate activation result that deviates from the benign mean along a direction of low variance in the benign distribution may indicate a policy-relevant signal even if the magnitude of the deviation is small in absolute terms.

In some embodiments, the classification module 122 can be configured to apply dynamic mode decomposition (DMD) to a sequence of intermediate activation results to identify coherent modes of temporal evolution. DMD can separate slowly-evolving coherent modes, which can represent candidate intent dynamics, from fast oscillatory modes, which can represent routing noise or token-level noise. Selected modes can be used as features for downstream probing by the trained probes, and selected frequencies can be used to gate filters applied to the probe outputs.

In some embodiments, the AI model(s) 106 can include a Mixture-of-Experts (MoE) architecture in which a router selects a subset of expert sub-networks to process each token of the input 104a and/or 104b. In an MoE architecture, the intermediate activation result at a given position is a function not only of the input 104a and/or 104b but also of which expert sub-networks the router selected, which can cause the same underlying intent to appear in different regions of representation space depending on the routing path.

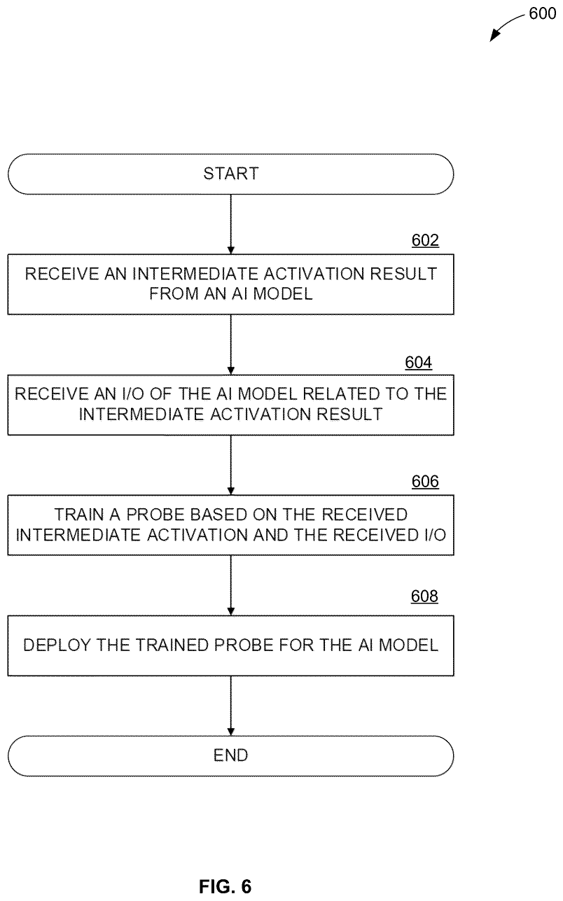

In some embodiments, the classification module 122 can be configured to monitor a distributional distance between production routing statistics and the routing statistics observed during probe training. For example, the classification module 122 can compute a divergence measure, such as a Kullback-Leibler divergence, a Jensen-Shannon divergence, or a total variation distance, between the production routing distribution and the training routing distribution on a sliding window. When the divergence exceeds a tunable threshold, the classification module 122 can trigger a recalibration procedure, which can include retraining affected probes on newly collected data and updating the probe version number, as described with respect to FIG. 6.

In some embodiments, the classification module 122 can be configured to receive, as an auxiliary input to the trained probe, a routing state indicating the subset of expert sub-networks selected to process the input 104a and/or 104b. The routing state can include a one-hot or multi-hot encoding of the selected experts and, optionally, associated gate weights. By receiving the routing state as an auxiliary input, the trained probe can learn a decision boundary in the joint space of the intermediate activation result and the routing state, rather than in the activation space alone, which can increase the accuracy of the classification without requiring the trained probe to be nonlinear. For example, a linear classifier that receives both the intermediate activation result and the routing state as inputs can achieve higher classification accuracy than a linear classifier that receives only the intermediate activation result, because the routing state provides additional information about the context in which the intermediate activation result was generated.

In some embodiments, the control action module 124 can be configured to generate control actions based on classification results produced by the classification module 122. The control action module 124 can receive the feedback result from the classification module 122 and determine an appropriate control action based on the likelihood that the input violates the policy and/or the AI model(s) 106 will generate an output that violates the policy. The control action module 124 can be configured to select from a range of control actions based on the severity and nature of the detected policy violation.

In some embodiments, the control action module 124 can be configured to generate a control action 112a directed to the business application 102, a control action 112b directed to the agent harness 132, and/or a control action 112c directed to the AI model(s) 106 through the inference layer 108. The control action 112c directed to the AI model(s) 106 can modify the AI model's processing during the same forward pass in which the intermediate activation result was generated, enabling the monitor and control system 120 to intervene before the output 110b is produced. The control action 112b directed to the agent harness 132 can modify the input 104b before it is sent to the AI model(s) 106 or modify the output 110b before it is returned to the business application 102. The control action 112a directed to the business application 102 can notify the business application 102 of the classification result and/or instruct the business application 102 to take a remediation action after the output 110a is generated.

In some embodiments, the control action can include altering one or more numerical values of the intermediate activation result based on a difference computed between a first set of activations associated with outputs that comply with the policy and a second set of activations associated with outputs that violate the policy, and providing the altered intermediate activation result to the AI model(s) 106 for continued processing. The difference between the first set and the second set can represent a direction in activation space along which the AI model's internal state transitions from policy-compliant to policy-violating behavior. By altering the intermediate activation result along this direction, the control action module 124 can steer the AI model's internal state toward the policy-compliant region of activation space. For example, the control action module 124 can compute a vector representing the mean difference between activations associated with policy-compliant outputs and activations associated with policy-violating outputs, and add a scaled version of this vector to the intermediate activation result to shift the AI model's processing toward generating a policy-compliant output. In some embodiments, the control action can include altering a weight value associated with at least one neuron of the AI model(s) 106, temporarily or permanently. In some embodiments, the control action can include pruning at least one neuron of the AI model(s) 106. In some embodiments, the control action can include halting transmission of the output 110a or 110b to the business application 102 or to a device that originated the input 104a. In some embodiments, the control action can include re-prompting the AI model(s) 106. In some embodiments, the control action can include intervening on the agent harness 132.

In some embodiments, the monitoring module 126 can be configured to monitor the operation of the AI model(s) 106 and to coordinate with the classification module 122 and the control action module 124. The monitoring module 126 can be configured to collect data about the AI model's processing, including intermediate activation results, classification results, feedback results, and control actions, and to make this data available for analysis, auditing, and retraining purposes.

In some embodiments, the monitoring module 126 can be configured to log the intermediate activation result, the classification, and the control action. The monitoring module 126 can be configured to store the logged data in the log database 130 for observability purposes. The logged data can be utilized for incident forensics, compliance auditing, and performance evaluation of the trained probes. In some embodiments, the monitoring module 126 can be configured to retrain the trained probes based on the logged intermediate activation results and the logged classifications. For example, the monitoring module 126 can periodically collect logged data from the log database 130, generate updated training datasets, and retrain the trained probes to maintain classification accuracy as the AI model(s) 106 or the policy evolves over time.

In some embodiments, the monitoring module 126 can be configured to check for drift in the probes behavior by comparing the distribution of classification scores observed during a current time window against the distribution of classification scores observed during a baseline period. When the distributional distance exceeds a threshold, the monitoring module 126 can trigger a retraining procedure and/or generate an alert indicating that probes behavior may have shifted.

In some embodiments, the monitoring module 126 can be configured to generate reports and alerts based on the logged data. Reports can include summaries of classification results, control actions taken, policy violations detected, and probe performance metrics over a specified time period. Alerts can be generated in response to specific events, such as a classification score exceeding a threshold, a drift detection event, or a probe performance degradation event, and can be transmitted to the external event management system(s) 128 and/or the business application 102.

As shown in FIG. 1, the monitor and control system 120 can be connected to external event management system(s) 128 and a log database 130. In some embodiments, the external event management system(s) 128 can include a security information and event management (SIEM) system, a security orchestration, automation, and response (SOAR) system, a threat intelligence platform (TIP), or any suitable combination thereof. The external event management system(s) 128 can be configured to receive classification results, control actions, and/or monitoring data from the monitor and control system 120 and to incorporate this data into broader organizational security workflows.

In some embodiments, the log database 130 can be configured to store intermediate activation results, classification results, feedback results, control actions, and/or any other suitable data generated by the monitor and control system 120. The log database 130 can be configured to support querying and analysis of historical monitoring data, enabling the monitor and control system 120 to identify trends, detect drift in the AI model's behavior over time, and generate reports for compliance and auditing purposes. For example, the log database 130 can store a time-series of classification scores for each input processed by the AI model(s) 106, enabling the monitoring module 126 to detect changes in the distribution of classification scores that may indicate a shift in the AI model's behavior or a change in the types of inputs being processed.

In some embodiments, the environment 100 can be deployed in a context where the AI model(s) 106 operates within the agent harness 132 that provides tools, context management, and an execution environment for the AI model(s) 106 in a loop of reasoning and action. An agent harness can refer to an orchestration framework that enables the AI model(s) 106 to interact with external tools, databases, and services in the loop. For example, the agent harness 132 can provide the AI model(s) 106 with access to code execution environments, file systems, web browsers, and/or other tools that the AI model(s) 106 can invoke during processing.

In such embodiments, the monitor and control system 120 can be configured to monitor intermediate activation results at various hook points within the loop, including context ingress points where external and internal agent observational data enters the AI model's context, reasoning points where the AI model(s) 106 reason, plan, and form intent, action egress points where the AI model(s) 106 emits tool calls or other actions, and memory ingress and egress points where the AI model(s) 106 reads from or writes to long-term memory. The control action module 124 can be configured to apply control actions at these hook points to enforce policies governing the behavior of the AI model(s) 106 within the agent harness 132. For example, the control action module 124 can intercept an intent formed before the tool call is emitted by the AI model(s) 106 and block the tool call if the activation-based classification module 122 determines that the tool call is likely to result in a policy violation.

In some embodiments, the agent harness 132 can be configured to execute an iterative reasoning loop that repeats until the AI model(s) 106 produces a text-only response with no tool calls. Each iteration of the reasoning loop can include a context assembly phase in which a context is assembled, a model reasoning phase in which the AI model(s) 106 processes the context to form an internal state encoding what the AI model knows and what it intends to do, a tool execution phase in which the AI model(s) 106 emits an action such as a tool call, a message, or a code block that the agent harness 132 is configured to execute in a sandboxed environment, and a result injection phase in which the tool output is appended back into the context as new state for the next iteration. The intermediate activation results generated during the model reasoning phase can encode the AI model's intent before the intent is externalized as an action, enabling the monitor and control system 120 to detect policy-violating intent before the AI model(s) 106 emits a tool call or other action.

In some embodiments, the context assembled at the context assembly phase can include a plurality of typed data elements organized as a setup component and a sequence of turns. The setup component can include tool definitions, Model Context Protocol (MCP) definitions, agent-to-agent (A2A) definitions, policy definitions, permissions, skills, environment configuration, and hooks. Each turn in the sequence can include one or more of: a user message, an agent message, a thinking element representing the AI model's chain-of-thought reasoning, a planning element representing a structured plan, a compaction element representing a summarized or compressed version of prior context, a tool call, a user-in-the-loop decision, a tool response, or a summary. The monitor and control system 120 can be configured to process the typed data elements to reconstruct a typed trace of the agent's decision process, enabling structured analysis of the agent's behavior.

In some embodiments, the control action module 124 can be configured to apply control actions at each phase of the reasoning loop. The control actions can include pausing execution of the reasoning loop, generating an alert or notification, logging the intermediate activation result and the classification, permitting the agent to continue processing, aborting the current iteration or the entire reasoning loop, steering the AI model's internal state by altering intermediate activation results, or changing the context by modifying, adding, or removing data elements before the next iteration. In some embodiments, the monitor and control system 120 can be configured to model the agent's behavior as a state machine in which each state corresponds to a phase of the reasoning loop and transitions between states are governed by the actions emitted by the AI model(s) 106 and the observations returned by the agent harness 132. The monitor and control system 120 can be configured to evaluate policy compliance at each state transition. In some embodiments, the monitor and control system 120 can be configured to represent all sequences of actions and resulting states as a directed graph, where on-policy states correspond to states consistent with the policy and off-policy states correspond to states that violate the policy, and to detect when the agent is approaching an off-policy state by classifying intermediate activation results at the reasoning phase to determine the agent's intent before the agent visits the off-policy state.

In some embodiments, the classification module 122 can be configured to detect agent behavioral patterns that correlate with policy-violating outcomes by classifying intermediate activation results generated at the hook points described above. An agent behavioral pattern can refer to a repeated, recognizable pattern in the AI model's objective, plan, action distribution, or constraint responsiveness that correlates with risky outcomes. The classification module 122 can be configured to detect agent behavioral patterns by monitoring a set of intent primitives including an objective proxy indicating what the AI model appears to optimize for as revealed by choices under constraints, a plan representation indicating the structured plan the AI model commits to before acting, an action policy indicating the distribution over actions or tool calls given the same situation, and a constraint salience indicating whether constraints materially change what the AI model chooses.

In some embodiments, agent behavioral patterns can include context assembly patterns such as reconnaissance patterns in which the AI model scans for secrets, credentials, or security boundaries without a task-relevant reason, context manipulation patterns in which the AI model or a prior agent run modifies persistent configuration files to inject permissive rules or suppress safety checks, and context window saturation patterns in which the AI model loads excessive context to force eviction of safety-relevant instructions during compaction. Agent behavioral patterns can also include model reasoning patterns such as goal smuggling patterns in which the AI model embeds tasks in a plan that were not part of the user's original request, sub-agent delegation patterns in which the AI model dispatches sub-agents with overly broad instructions, and deceptive reasoning patterns in which the AI model's internal reasoning contains objectives not reflected in its visible outputs. The classification module 122 can be configured to detect deceptive reasoning patterns by classifying intermediate activation results generated at the reasoning point, where the intermediate activation results encode the AI model's intent before the intent is externalized as text, enabling detection of cases where the AI model's internal reasoning diverges from its visible outputs.

In some embodiments, agent behavioral patterns can include tool execution patterns such as command chaining and obfuscation patterns in which the AI model bundles benign operations with malicious ones, payload injection patterns in which the AI model writes code containing embedded backdoors or exfiltration mechanisms, persistence installation patterns in which the AI model modifies configuration files to persist influence beyond the current session, defense evasion patterns in which the AI model cleans up evidence after performing sensitive operations, and exfiltration patterns in which the AI model sends data to external endpoints or embeds sensitive data in code artifacts. Agent behavioral patterns can also include loop control patterns such as infinite loop exploitation patterns in which the AI model continues making tool calls indefinitely, and premature termination patterns in which the AI model terminates while leaving behind undisclosed persistent artifacts.

In some embodiments, the classification module 122 can be configured to detect temporal splitting patterns in which the AI model distributes a harmful action across multiple iterations of the reasoning loop such that no single iteration appears malicious but the composition across iterations constitutes a policy violation. In some embodiments, the classification module 122 can be configured to detect temporal splitting patterns by analyzing intermediate activation results across multiple iterations using the sequential processing techniques described above, including the sliding window aggregation, the cumulative sum detection, and the hidden Markov model regime inference. In some embodiments, the classification module 122 can be configured to detect goal drift by comparing intent primitives estimated from intermediate activation results at a current iteration against intent primitives estimated at prior iterations, and generating a feedback result when the change exceeds a threshold. Goal drift can include increases in retrieval breadth across steps, riskier tool ordering patterns, repeated boundary testing for permissions, and increasing preference for task completion over policy compliance. In some embodiments, the classification module 122 can detect instrumental convergence patterns in which the AI model drifts toward helper subgoals such as acquiring more information than needed, requesting broader access, or removing obstacles, by classifying intermediate activation results to identify the stance toward these subgoals even when the surface form of the AI model's outputs remains plausible. The trained probes can take advantage of the property that intermediate activation results converge to similar representations for the same high-level intent regardless of which specific tools or action sequences the agent uses, enabling detection from a small number of training examples that capture the high-level concept rather than enumerating every possible tool and action sequence.

In some embodiments, the context for the next iteration of the reasoning loop can be formed by compacting the previous context, the action, and the observation, where compacting includes summarizing or compressing prior context to fit within a context window of the AI model(s) 106. The monitor and control system 120 can be configured to perform a policy preservation check during the compaction by classifying intermediate activation results generated before and after the compaction to determine whether policy-relevant information has been lost. For example, the classification module 122 can classify a first intermediate activation result generated when the AI model(s) 106 processes the context prior to compaction and classify a second intermediate activation result generated when the AI model(s) 106 processes the context after compaction, and compare the classifications to determine whether the compaction caused a change in the likelihood that the AI model(s) 106 will violate the policy.

In some embodiments, when the comparison indicates that policy-relevant information has been lost during compaction, the control action module 124 can intervene by restoring the policy information to the context, blocking the compaction, re-injecting policy instructions into the compacted context, or generating an alert to the monitoring module 126. In some embodiments, the policy preservation check can also be applied at memory ingress and egress points where the AI model(s) 106 reads from or writes to long-term memory, to verify that policy constraints are preserved across memory operations. For example, the classification module 122 can classify intermediate activation results generated when the AI model(s) 106 writes to long-term memory and when the AI model(s) 106 reads from long-term memory, and compare the classifications to verify that the policy remains intact after the memory operation.

In some embodiments, the trained probes of the classification module 122 can be validated using adversarial examples generated from activation-space analysis. Adversarial examples can be generated by analyzing the activation space of the AI model(s) 106 to identify directions along which the trained probes are most vulnerable to misclassification, and generating inputs that push the AI model's intermediate activation results along those directions.

In some embodiments, the adversarial examples can be utilized to verify that the trained probes maintain detection accuracy against adversarial inputs and to identify weaknesses in the trained probes that can be addressed through retraining or architectural modifications. For example, the classification module 122 can periodically generate a set of adversarial examples, evaluate the trained probes against the adversarial examples, and retrain the trained probes on any adversarial examples that were misclassified.

In some embodiments, the training and deployment of the trained probes can be organized using a typed computation graph framework that separates specification, instantiation, and execution of training operations. The computation graph framework can enable content-addressable artifact tracking, where each training operation and its outputs are uniquely identified by a hash of the operation's dependencies and parameters, enabling reproducible training pipelines and provenance tracking for trained probes.

In some embodiments, probe training can utilize a generator-discriminator pattern in which a first process generates candidate training solutions and a second process formalizes the solutions into the training pipeline. The generator process can explore approaches to training data generation and probe architecture selection, while the discriminator process can evaluate the quality of the generated solutions and integrate them into the production training pipeline. This pattern can enable rapid iteration on probe training strategies while maintaining the rigor and reproducibility of the production training pipeline.

FIG. 2 illustrates a flowchart of a method 200 for monitoring and controlling an AI model during processing of an input, according to some embodiments of the technology described herein. Referring to FIG. 2, the monitor and control system 120 of FIG. 1 can perform the method 200 during run-time inference of the AI model(s) 106, such that the method 200 operates on intermediate activation results generated during the same forward pass in which the input 104a and/or 104b are being processed.

The method 200 begins with a step 202, where the classification module 122 can be configured to select a layer of the AI model(s) 106 from which to obtain an intermediate activation result. As described with respect to FIG. 1, the classification module 122 can be configured to select the layer from a preselected group of layers, select the layer based on a compression-based criterion such as a minimum description length criterion, select the layer from a module of the AI model(s) 106, such as a residual stream, or select the layer using any other suitable selection approach.

At step 204, the classification module 122 can be configured to receive the intermediate activation result generated by the selected layer during processing of the input 104a and/or 104b. The intermediate activation result includes numerical values generated by the selected layer and represents the AI model's internal processing state at the selected layer. In some embodiments, the classification module 122 can be configured to receive a plurality of intermediate activation results from a plurality of selected layers. In some embodiments, the classification module 122 can be configured to preprocess the intermediate activation result prior to classification, as described with respect to FIG. 1.

At step 206, the classification module 122 can be configured to utilize a trained probe to classify the intermediate activation result to determine a likelihood that the input violates a policy and/or the AI model(s) 106 will generate an output that violates a policy. As described with respect to FIG. 1, the trained probe can include any suitable machine learning model. In some embodiments, the classification module 122 can be configured to utilize a plurality of trained probes, each associated with a weight, and generate the classification by combining outputs of the plurality of trained probes according to their respective weights. In some embodiments, the classification module 122 can be configured to perform the classification on an aggregated result generated by aggregating probe outputs over a sliding window, on a cumulative sum of classification scores, on a posterior distribution over latent states of a hidden Markov model, or on a distance measure accounting for the covariance of a benign activation distribution, as described with respect to FIG. 1.

At step 208, the classification module 122 can be configured to generate a feedback result based on the classification and provide the feedback result to the control action module 124. The feedback result can indicate the likelihood that the input violates the policy and/or the AI model(s) 106 will generate an output that violates the policy, and can specify a control action to be applied.

At step 210, the control action module 124 can be configured to modify processing of the input 104a and/or 104b by the AI model(s) 106 by applying a control action based on the feedback result. As described with respect to FIG. 1, the control action module 124 can be configured to apply the control action by altering one or more numerical values of the intermediate activation result and providing the altered intermediate activation result to the AI model(s) 106 for continued processing, altering a weight value associated with at least one neuron of the AI model(s) 106, pruning at least one neuron of the AI model(s) 106, re-prompting the agent harness 132 or the AI model(s) 106, halting transmission of the output 110a and/or 110b, or any suitable combination thereof. In some embodiments, the AI model(s) 106 can be configured to pause execution after generating the intermediate activation result at step 204 and resume execution after the control action module 124 applies the control action at step 210, such that the control action affects generation of the output 110a and/or 110b. In some embodiments, the control action module 124 can be configured to apply the control action to the agent harness 132, for example by blocking a tool call or modifying the input 104b before it is provided to the AI model(s) 106. In some embodiments, the monitoring module 126 can be configured to log the intermediate activation result, the classification, and the control action, as described with respect to FIG. 1.

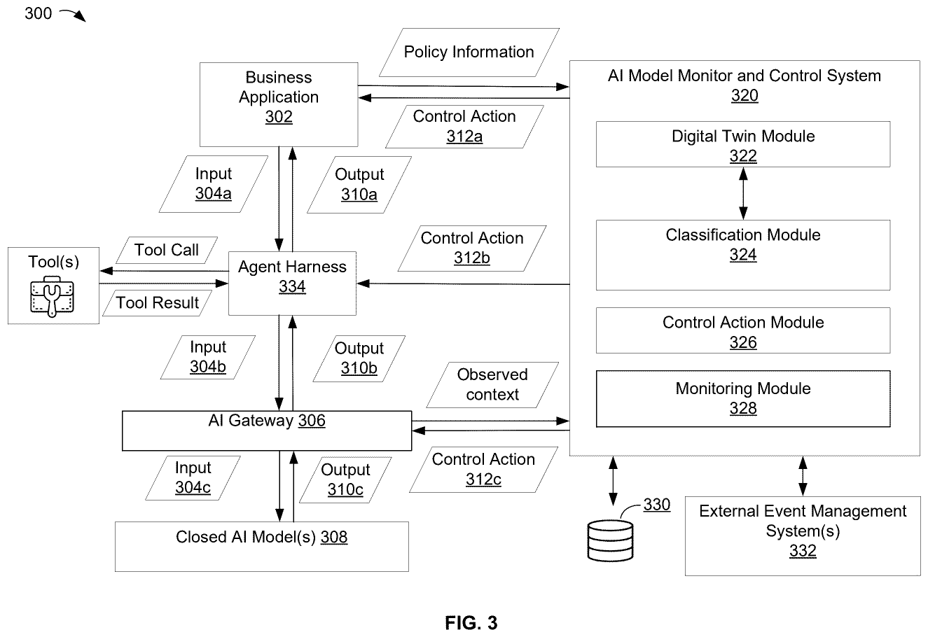

FIG. 3 illustrates a block diagram of a closed AI system environment 300 configured for monitoring and controlling AI model operations through a gateway, according to some embodiments of the technology described herein. Referring to FIG. 3, the closed AI system environment 300 (also referred to as “environment 300”) can be configured to enable run-time monitoring and control of one or more generative AI models when the AI model(s) are not directly accessible. The environment 300 is referred to as “closed” because the internal weights, layers, and/or intermediate activation results of the Closed AI model(s) 308 cannot be directly observed or modified during processing. For example, the Closed AI model(s) 308 can be hosted by a third-party provider and accessed through an application programming interface (API), such that the environment 300 has access only to the inputs sent to and the outputs received from the AI model(s) 308. As illustrated, the environment 300 includes a business application 302, an agent harness 334, an AI gateway 306, AI model(s) 308, and an AI model monitor and control system 320 (also referred to as “monitor and control system 320”).

In operation, the business application 302 sends an input 304a to the agent harness 334. The agent harness 334 processes the input and sends an input 304b to the AI gateway 306. The AI gateway 306 intercepts the input 304b and forwards an input 304c to the Closed AI model(s) 308 for processing. The Closed AI model(s) 308 generates an output 310c, which is returned to the AI gateway 306. The AI gateway 306 returns an output 310b to the agent harness 334, which processes the output and sends an output 310a to the business application 302.

In some embodiments, the AI gateway 306 provides observed context to the monitor and control system 320. The observed context can include the input 304b and/or 304c, the output 310b and/or 310c, tool call data, and/or agent state data intercepted from traffic between the agent harness 334 and the AI model(s) 308. The monitor and control system 320 processes the observed context using the digital twin module 322 to generate intermediate activation results, classifies the intermediate activation results using trained probes to determine a likelihood that an input and/or an output of the Closed AI model(s) 308 violates a policy, and applies a control action based on the classification. The monitor and control system 320 can be configured to provide a control action 312a to the business application 302, a control action 312b to the agent harness 334, and/or a control action 312c to the AI gateway 306. Each component of the environment 300 will be described in turn.

As shown in FIG. 3, the business application 302 can be configured to send the input 304a to the agent harness 334 and to receive the output 310a from the agent harness 334. The business application 302 can represent any software application, service, or system that utilizes the Closed AI model(s) 308 to process inputs and generate outputs, as described with respect to the business application 102 of FIG. 1. In some embodiments, the agent harness 334 can be configured to make tool calls to external tools and databases that store and manage data utilized by the Closed AI model(s) 308 during processing. The business application 302 can include business logic and communication pathways using any suitable protocol such as Model Context Protocol (MCP), Hypertext Transfer Protocol (HTTP), or any suitable combination thereof. In some embodiments, the business application 302 can be configured to provide policy information to the monitor and control system 320, where the policy information specifies rules, constraints, and/or requirements that the output 310 of the Closed AI model(s) 308 is expected to satisfy.

In some embodiments, the business application 302 can be configured to receive a control action 312a from the monitor and control system 320. The control action 312a can include, for example, a notification that the Closed AI model(s) 308 generated or is likely to generate an output that violates a policy, an instruction to halt delivery of the output 310a to a user or device that originated the input 304a, a modified version of the output 310a in which policy-violating content has been removed or altered, and/or any other suitable action. The monitor and control system 320 sits between the business application 302, the agent harness 334, and the Closed AI model(s) 308 through the AI gateway 306, enabling the monitor and control system 320 to observe and control the interaction between the business application 302 and the Closed AI model(s) 308 without requiring direct access to the AI model's internal states.

In some embodiments, the agent harness 334 can be configured to receive a control action 312b from the monitor and control system 320. The control action 312b can include, for example, an instruction to not execute a tool call that is about to be invoked by the agent harness 334, an instruction to modify the input 304b before forwarding to the AI gateway 306, an instruction to modify the output 310b before returning to the business application 302, and/or instructing the agent harness 334 to discard the output 310b and submit a new input 304b to the AI gateway 306, which forwards the new input as 304c to the Closed AI model(s) 308, effectively re-prompting the Closed AI model(s) 308 through the AI gateway 306. The agent harness 334 can provide tools, context management, and an execution environment for the Closed AI model(s) 308 in a loop of reasoning and action, as described with respect to the agent harness 132 of FIG. 1.

In some embodiments, the input processed by the Closed AI model(s) 308 can include a direct input and an agent-generated input. The direct input can correspond to the input 304a originating from a user or external system through the business application 302. The agent-generated input can correspond to the input 304b, which can include context assembled by the agent harness 334 from prior iterations of the reasoning loop, such as tool results, retrieved documents, memory reads, compacted context, the Closed AI model's own prior outputs, and system instructions injected by the agent harness 334. The classification module 324 can be configured to classify intermediate activation results generated by the digital twin module 322 to determine a likelihood that the direct input and/or the agent-generated input violates a policy. For example, classifying intermediate activation results based on the direct input can enable detection of prompt injection attacks, and classifying intermediate activation results based on the agent-generated input can enable detection of reliability issues in long-running agents, such as goal drift, policy loss during context compaction, or accumulation of misleading context across iterations.

As shown in FIG. 3, the AI gateway 306 can be configured to intercept traffic between the agent harness 334 and the AI model(s) 308. The AI gateway 306 can serve as a trust boundary within an organization for both outgoing traffic (inputs sent to the AI model(s) 308) and incoming traffic (outputs received from the AI model(s) 308). In some embodiments, the AI gateway 306 can be configured to operate as a proxy that receives requests from the agent harness 334, forwards the requests to the AI model(s) 308, receives responses from the AI model(s) 308, and forwards the responses to the agent harness 334. In some embodiments, the AI gateway 306 can be configured to provide observed context to the monitor and control system 320, the observed context including the input 304b and/or 304c, the output 310b and/or 310c, tool call data, and/or agent state data intercepted from traffic between the agent harness 334 and the AI model(s) 308, enabling the monitor and control system 320 to analyze the observed context and apply control actions. In some embodiments, the AI gateway 306 can include agent-specific proxies, each proxy configured to intercept communications between a corresponding agent harness and the AI model(s) 308. For example, a first proxy can be configured to intercept communications between a first agent harness and a first model provider, and a second proxy can be configured to intercept communications between a second agent harness and a second model provider.

In some embodiments, the AI gateway 306 can be configured to receive a control action 312c from the monitor and control system 320. The control action 312c can include, for example, an instruction to modify the input 304c before forwarding to the AI model(s) 308, an instruction to modify the output 310c before returning to the agent harness 334, and/or an instruction to halt forwarding of the output 310c entirely.

In some embodiments, the AI gateway 306 can be configured to modify the input 304b received from the agent harness 334 before forwarding the input 304c to the Closed AI model(s) 308 based on a control action received from the monitor and control system 320. For example, the AI gateway 306 can be configured to append safety instructions to the input 304b, remove potentially harmful content from the input 304b, or replace the input 304b with a modified version that is less likely to elicit a policy-violating output from the AI model(s) 308. In some embodiments, the AI gateway 306 can be configured to modify the output 310c received from the Closed AI model(s) 308 before forwarding the output 310b to the agent harness 334. For example, the AI gateway 306 can be configured to redact sensitive information from the output 310c, replace policy-violating portions of the output 310c with alternative content, or block the output 310c entirely and return an error message to the agent harness 334.

In some embodiments, the output 310c generated by the Closed AI model(s) 308 can include an instruction directed to the agent harness 334, such as a tool call, a code execution request, or another action directive that the agent harness 334 would execute as part of the reasoning loop. The AI gateway 306 can intercept the output 310c containing the instruction before the output 310c is forwarded as 310b to the agent harness 334, and provide the output 310c to the monitor and control system 320 as part of the observed context. The monitor and control system 320 can classify the output 310c using the digital twin module 322 and the classification module 324 to determine whether execution of the instructed action by the agent harness 334 is likely to result in a policy violation. Based on the classification, the monitor and control system 320 can issue a control action 312c to the AI gateway 306 instructing the AI gateway 306 to modify the output 310c before forwarding it as 310b to the agent harness 334, to halt forwarding of the output 310c entirely, or to submit a new input 304c to the Closed AI model(s) 308 that steers the Closed AI model(s) 308 away from the policy-violating action.

In some embodiments, the AI gateway 306 can be configured to support detection of security events before the first token of the output 310c is generated by the AI model(s) 308. The AI gateway 306 can be configured to provide the intercepted input 304b to the monitor and control system 320 immediately upon receipt, enabling the monitor and control system 320 to classify the input 304b and determine whether the input 304b is likely to elicit a policy-violating output before the Closed AI model(s) 308 begins processing. This can enable low-latency detection and intervention that is scalable across high volumes of requests.

As shown in FIG. 3, the Closed AI model(s) 308 can include one or more generative AI models hosted by a third-party provider and accessed through an API. In some embodiments, the Closed AI model(s) 308 can include large language models such as those provided by commercial AI service providers, image generation models, video generation models, or any suitable combination thereof. Because the Closed AI model(s) 308 are hosted externally, the internal weights, layers, and intermediate activation results of the Closed AI model(s) 308 are not directly accessible to the environment 300. The environment 300 can observe only the inputs sent to and the outputs received from the Closed AI model(s) 308 through the AI gateway 306.

As shown in FIG. 3, the monitor and control system 320 can be configured to monitor, classify, and control the interaction between the business application 302 and the AI model(s) 308. The monitor and control system 320 includes a digital twin module 322, a classification module 324, a control action module 326, and a monitoring module 328. The monitor and control system 320 can be configured to receive observed context from the AI gateway 306 and generate control actions that are communicated back to the business application 302, the agent harness 334, and/or the AI gateway 306. The digital twin module 322 can generate intermediate activation results at least in part based on the observed context and provide the intermediate activation results to the classification module 324 for classification.

For example, when the business application 302 sends an input 304a through the agent harness 334 requesting the Closed AI model(s) 308 to generate a response, the AI gateway 306 can intercept the input 304b and provide observed context to the monitor and control system 320. The digital twin module 322 can process the observed context to generate intermediate activation results, and the classification module 324 can classify the intermediate activation results to determine whether the input and/or an output of the Closed AI model(s) 308 violates an organizational security policy. Based on the classification, the control action module 326 can apply a control action 312c through the AI gateway 306 to modify the input 304c before forwarding to the Closed AI model(s) 308 and/or modify the output 310c before returning to the agent harness 334.

In some embodiments, the digital twin module 322 can be configured to generate intermediate activation results that approximate the internal processing state of the Closed AI model(s) 308 without requiring direct access to the AI model's internal layers. The digital twin module 322 can be configured to address the challenge that the Closed AI model(s) 308 are not directly accessible by providing an alternative source of activation-level signals that can be classified by the trained probes of the classification module 324.

In some embodiments, the digital twin module 322 can include a context normalizer configured to receive observed context from the AI gateway 306 and normalize the observed context into a unified data model prior to generating the intermediate activation results. The context normalizer can standardize context from different agent harnesses that use different formats, protocols, and data structures into a common representation suitable for processing by the digital twin module 322.

In some embodiments, the digital twin module 322 can include a second AI model, wherein internal weights and intermediate activation results of the second AI model are directly accessible during processing of the input. In some embodiments, the second AI model can be configured to project the input 304b and/or 304c into a lower-dimensional representation that preserves the information relevant to the classification task. The classification module 324 can then classify the intermediate activation result generated by the second AI model as if it were an intermediate activation result generated by the Closed AI model(s) 308 directly. In some embodiments, the second AI model does not need to match the behavior of the AI model(s) 308, but instead needs to generate intermediate activation results that are discriminative for classifying whether the input and/or an output of the Closed AI model(s) 308 violates the policy.

In some embodiments, the digital twin module 322 can be configured to implement API-level shadowing, where the digital twin module 322 maintains a local copy of a generative AI model (e.g., a smaller proxy model) and processes the input 304 using the local model with the same prompt that is sent to the closed AI model(s) 308. The digital twin module 322 can compare the local model's output against policy rules to determine whether the Closed AI model(s) 308 would produce an unsafe output. In some embodiments, the local model can be an open-weight model that provides direct access to intermediate activation results, enabling the classification module 324 to classify the intermediate activation results using trained probes as described with respect to FIG. 1.

In some embodiments, the digital twin module 322 can be configured to implement output-only probing, where the digital twin module 322 monitors the intent of the tool arguments and textual rationale emitted by the AI model(s) 308 and runs a lightweight classifier and/or fine-tuned policy model on the emitted text to detect forbidden intents. For example, the digital twin module 322 can analyze the text of a tool call emitted by the Closed AI model(s) 308 to detect whether the tool call is likely to result in a policy violation, such as a request to delete sensitive data or access restricted resources.

In some embodiments, the digital twin module 322 can be configured to implement meta-querying, where the digital twin module 322 issues its own requests to the AI model(s) 308 through the AI gateway 306 with probe prompts designed to elicit information about the closed AI model's stance on a particular topic or action. For example, the digital twin module 322 can send a probe prompt such as “If you were to delete data for user 42, would you log the action first?” to the closed AI model(s) 308 and analyze the response to infer whether the Closed AI model(s) 308 is likely to proceed unsafely when processing the actual input 304.

In some embodiments, the digital twin module 322 can be configured to implement distillation-based twinning, where the digital twin module 322 collects a log of input-output pairs from the Closed AI model(s) 308 over time and trains a small, fast student model to mimic the mapping between inputs and outputs of the closed AI model(s) 308. The student model can be more transparent and easier to instrument than the AI model(s) 308, enabling the classification module 324 to access intermediate activation results from the student model for classification purposes. In some embodiments, the student model can be retrained periodically as additional input-output pairs are collected, improving the fidelity of the student model over time.

In some embodiments, the digital twin module 322 can be configured to provide activation-derived signals to the classification module 324 in the form of probes, sparse feature activations, layerwise summaries, anomaly scores, and/or other compressive representations. In closed-weight settings where the Closed AI model(s) 308 are not directly accessible, the digital twin module 322 can provide structured plans, tool traces, retrieval traces, and/or counterfactual behavior as partial substitutes for direct activation-level signals. In some embodiments, the digital twin module 322 can approximate activation-derived signals through high-fidelity digital twins of the AI model(s) 308.

In some embodiments, the classification module 324 can be configured to receive intermediate activation results or other signals from the digital twin module 322 and to classify the signals using one or more trained probes, as described with respect to the classification module 122 of FIG. 1. The classification module 324 can be configured to determine a likelihood that the input and/or an output of the Closed AI model(s) 308 violates a policy based on the signals received from the digital twin module 322. In some embodiments, the classification module 324 can be configured to utilize the same types of trained probes, preprocessing techniques, layer selection approaches, sequential processing techniques, and distance-based classification approaches as described with respect to the classification module 122 of FIG. 1.

In some embodiments, the classification module 324 can be configured to receive policy information from the business application 302 and to train the trained probes based on the policy information, as described with respect to the classification module 122 of FIG. 1. In some embodiments, the trained probes of the classification module 324 can be trained using intermediate activation results generated by the digital twin module 322 rather than intermediate activation results generated by the closed AI model(s) 308 directly. The trained probes can be trained to discriminate between signals associated with inputs and/or outputs that comply with the policy and signals associated with inputs and/or outputs that violate the policy, regardless of whether the signals are generated by the closed AI model(s) 308 directly or by the digital twin module 322.

In some embodiments, the control action module 326 can be configured to generate control actions based on classification results produced by the classification module 324. In some embodiments, because the Closed AI model(s) 308 are not directly accessible, the control action module 326 can be configured to apply control actions through the agent harness 334 and/or the AI gateway 306 rather than directly to the AI model(s) 308. In some embodiments, the control action module 326 can be configured to instruct the AI gateway 306 to modify the input 304c before forwarding the input 304c to the AI model(s) 308. In some embodiments, the control action module 326 can be configured to instruct the AI gateway 306 to modify the output 310c received from the Closed AI model(s) 308 before forwarding the output 310b to the agent harness 334. In some embodiments, the control action module 326 can be configured to instruct the AI gateway 306 to halt forwarding of the output 310c entirely.

In some embodiments, the control action module 326 can be configured to generate a control action 312a directed to the business application 302. The control action 312a can include a notification that the Closed AI model(s) 308 generated or is likely to generate an output that violates a policy, an instruction to the business application 302 to take a remediation action, and/or any other suitable action. For example, the control action module 326 can be configured to notify the business application 302 that a user's request was blocked because the Closed AI model(s) 308 was likely to generate a response containing sensitive information that violates the organization's data privacy policy.

In some embodiments, the monitoring module 328 can be configured to monitor the interaction between the business application 302 and the Closed AI model(s) 308 through the AI gateway 306 and to coordinate with the classification module 324 and the control action module 326. The monitoring module 328 can be configured to collect data about the intercepted traffic, including inputs, outputs, classification results, feedback results, and control actions, and to make this data available for analysis, auditing, and retraining purposes.

In some embodiments, the monitoring module 328 can be configured to log the intercepted data, the classification, and the control action. The monitoring module 328 can be configured to store the logged data in a log database 330 for observability purposes. The logged data can be utilized for incident forensics, compliance auditing, performance evaluation of the trained probes, and retraining of the digital twin module 322 and/or the trained probes of the classification module 324. For example, the monitoring module 328 can periodically collect logged input-output pairs from the log database 330 and provide them to the digital twin module 322 for retraining the distillation-based student model, improving the fidelity of the digital twin over time.

As shown in FIG. 3, the monitor and control system 320 can be connected to external event management system(s) 332 and the log database 330. In some embodiments, the external event management system(s) 332 can include a security information and event management (SIEM) system, a security orchestration, automation, and response (SOAR) system, a threat intelligence platform (TIP), or any suitable combination thereof. The external event management system(s) 332 can be configured to receive classification results, control actions, and/or monitoring data from the monitor and control system 320 and to incorporate this data into broader organizational security workflows.

In some embodiments, the log database 330 can be configured to store intercepted inputs, outputs, classification results, feedback results, control actions, digital twin signals, and/or any other suitable data generated by the monitor and control system 320. The log database 330 can be configured to support querying and analysis of historical monitoring data, enabling the monitor and control system 320 to identify trends, detect drift in the AI model's behavior over time, and generate reports for compliance and auditing purposes.

In some embodiments, the environment 300 can be deployed in a context where the Closed AI model(s) 308 operates within the agent harness 334 that provides tools, context management, and an execution environment for the AI model(s) 308, as described with respect to FIG. 1. In such embodiments, the AI gateway 306 can be configured to intercept traffic at various points within the agent harness 334, including context ingress points where external and internal agent observational data enters the AI model's context, reasoning points where the Closed AI model(s) 308 reason, plan, and form intent, action egress points where the Closed AI model(s) 308 emits tool calls or other actions, and memory ingress and egress points where the Closed AI model(s) 308 reads from or writes to long-term memory. The control action module 326 can be configured to apply control actions at these points to enforce policies governing the behavior of the Closed AI model(s) 308 within the agent harness 334. For example, the AI gateway 306 can intercept a tool call emitted by the Closed AI model(s) 308 and the classification module 324 can classify the tool call to determine whether the input and/or the tool call is likely to result in a policy violation, enabling the control action module 326 to block the tool call before it is executed.

In some embodiments, the environment 300 can be configured to operate in conjunction with the environment 100 of FIG. 1. For example, an organization can deploy the environment 100 for AI model(s) that are hosted internally and directly accessible, and deploy the environment 300 for AI model(s) that are hosted by third-party providers and accessed through APIs. The monitor and control system 120 of FIG. 1 and the monitor and control system 320 of FIG. 3 can share the same classification module architecture, trained probes, policy information, and logging infrastructure, enabling a unified monitoring and control approach across both open and closed AI system environments.

In some embodiments, the digital twin module 322 can be configured to validate the fidelity of its signals by periodically injecting labeled calibration inputs into the stream of inputs sent to the Closed AI model(s) 308 through the AI gateway 306. The digital twin module 322 can evaluate the classification results produced by the classification module 324 on the calibration inputs against known expected results and trigger a recalibration or retraining procedure when the classification accuracy on the calibration inputs falls below a threshold. This calibration canary approach can make the fidelity of the digital twin module 322 continuously auditable without requiring cryptographic trust in the AI model provider's pipeline.

FIG. 4 illustrates a block diagram of an AI model processing an input to generate an output, according to some embodiments of the technology described herein. Referring to FIG. 4, the diagram depicts the flow of data through a neural network 404 from an input 402 to an output 412, with the neural network 404 including multiple layers arranged in sequence. The neural network 404 can be an implementation of the AI model(s) 106 of FIG. 1 and/or the Closed AI model(s) 308 of FIG. 3.

In some embodiments, the neural network 404 can include an AI model that is a parameterized function derived through training on data, designed to approximate complex relationships between inputs and outputs. For example, the neural network 404 can operate by mapping input vectors from a specified feature space to desired target outputs using learned parameters. In some embodiments, the neural network 404 can be a generative AI model designed to produce new content that mimics the structure and style of the data it was trained on. For example, the neural network 404 can include a Large Language Model (LLM) that generates coherent and contextually relevant text based on input prompts, a text-to-text transfer transformer that reframes natural language processing (NLP) tasks as text generation problems, or any other suitable generative model.

In some embodiments, the neural network 404 can include an image generation model. For example, models based on the Generative Adversarial Network (GAN) framework, which includes a generator and a discriminator competing in a zero-sum game to produce increasingly realistic outputs, can generate photorealistic images of human faces or produce images across categories by sampling from a learned distribution. It should be appreciated that the neural network 404 depicted in FIG. 4 is a simplified representation, as depicting a full neural network is not feasible for pedagogical purposes. Other variations of neural networks, generative AI models, and other suitable model architectures can utilize the techniques described herein without departing from the scope of the present disclosure.

In some embodiments, the neural network 404 can be optimized through gradient-based methods such as stochastic gradient descent (SGD). During training, the neural network 404 can be configured to minimize a loss function, which quantifies the difference between predicted outputs and true values, using iterative adjustments to its internal weights. In supervised learning, this process requires labeled data, whereas unsupervised models infer structure from unlabeled inputs. The architecture of the neural network 404, such as the number and type of layers, determines its capacity to learn nonlinear patterns, while regularization techniques can help prevent overfitting.

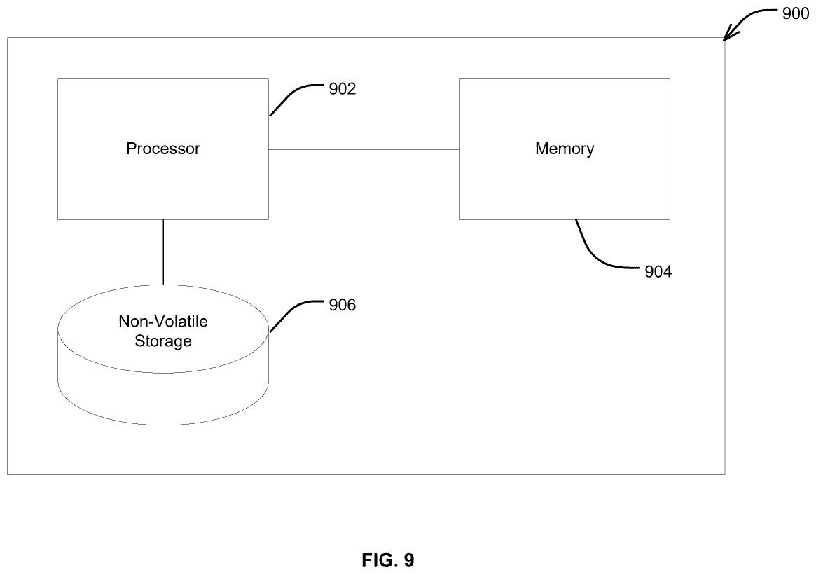

In some embodiments, the neural network 404, once trained, enters an inference phase, where the neural network 404 can be configured to generalize its learned function to make predictions on unseen data. Performance of the neural network 404 can be evaluated using metrics appropriate to the task, such as accuracy, mean squared error, or any other suitable metric. The trained neural network 404 encapsulates both the learned parameters and the computational structure necessary to reproduce its predictive behavior in deployment, and can leverage specialized hardware or frameworks for efficient execution, as described in further detail with respect to FIG. 9.

As shown in FIG. 4, the neural network 404 includes an input layer 406, hidden layers 408, and an output layer 410. The input layer 406 can be configured to receive data from the input 402 and pass the data into the hidden layers 408 for processing. In some embodiments, the input layer 406 is the initial layer of the neural network 404 that receives raw data, such as a vector representation of the input 402, and passes the data into the hidden layers 408 for processing. The input layer 406 includes a plurality of nodes, each node representing a single feature or dimension of the input vector, preserving the structure of the data as it flows into subsequent layers. In some embodiments, the size of the input layer 406 is fixed based on the number of features in the input data.

As shown in FIG. 4, the hidden layers 408 are intermediate layers positioned between the input layer 406 and the output layer 410. The hidden layers 408 can be configured to learn complex representations of the data. In some embodiments, each layer in the hidden layers 408 includes a plurality of neurons that apply weighted sums and non-linear activation functions to inputs from the previous layer, allowing the neural network 404 to model non-linear and high-dimensional relationships. The depth (number of layers) and width (number of neurons per layer) of the hidden layers 408 influence the neural network's capacity and expressiveness. In some embodiments, gradients computed during backpropagation update the weights within the hidden layers 408, enabling the neural network 404 to minimize the loss function over time. The hidden layers 408 collectively transform raw inputs into abstract and task-relevant features.

As shown in FIG. 4, the output layer 410 is the final layer of the neural network 404 and can be configured to produce the model's predictions, which are then provided as the output 412. The output layer 410 can be configured to transform the neural network's internal representations into a desired output format, such as probabilities, class labels, or continuous values, depending on the task. In some embodiments, the number of neurons in the output layer 410 corresponds to the dimensionality of the prediction space. Activation functions such as SoftMax, which converts raw outputs into probability distributions, sigmoid, which squashes values between 0 and 1, or other suitable functions can be applied to scale outputs appropriately, enabling interpretation as probabilities in classification tasks or unbounded values in regression. In some embodiments, the structure of the output layer 410 and the activation function applied at the output layer 410 can be aligned with the loss function used during training to ensure proper optimization.

As shown in FIG. 4, the neural network 404 can be configured to receive the input 402 and generate, by processing using the layers of the neural network 404, the output 412. During processing, a layer of the hidden layers 408 outputs an intermediate activation result 414. In some embodiments, the intermediate activation result 414 includes values of an activation function applied to the output of neurons within the hidden layers 408.

In some embodiments, activation in neural networks refers to the process of applying a function to the output of a neuron, transforming the output before passing it to the next layer as an input. Activation introduces non-linearity into the neural network 404. Without activation functions, the neural network 404 would only perform linear transformations, limiting its ability to model complex relationships. In some embodiments, an activation function can include ReLU (Rectified Linear Unit), which outputs zero for negative values and the input itself for positive values, sigmoid, which squashes values between 0 and 1 making it suitable for probability predictions, Tanh, which maps inputs to a range between −1 and 1, SoftMax, which is used in the output layer for classification tasks such as converting raw outputs into probability distributions, GeLU (Gaussian Error Linear Units), or any suitable combination thereof. The choice of activation function impacts the neural network's learning speed, capacity, and convergence. In some embodiments, an activation function can be applied element-wise to each neuron's output.

As shown in FIG. 4, the intermediate activation result 414 is depicted below the neural network 404. The intermediate activation result 414 represents values generated during processing within the neural network 404. The intermediate activation result 414 includes a plurality of numerical values that are received from an intermediate output of the neural network 404, such as from one or more of the hidden layers 408. The intermediate activation result 414 is utilized by the neural network 404 when generating the output 412. The intermediate activation result 414 is an intermediate result and is not utilized as the output 412 of the neural network 404, but instead is utilized to produce the output 412.

In some embodiments, the intermediate activation result 414 can be utilized in training an AI model monitoring system, such as the monitor and control system 120 of FIG. 1. The intermediate activation result 414 can be provided to the classification module 122 of FIG. 1 for use in training the trained probes, as described in further detail with respect to FIG. 5 and FIG. 6. In some embodiments, the intermediate activation result 414 can be utilized in applying a control action on the output 412 of the neural network 404 prior to generation of the output 412, as described with respect to FIG. 1 and FIG. 2. For example, the monitor and control system 120 of FIG. 1 can receive the intermediate activation result 414 from the inference layer 108, classify the intermediate activation result 414 using a trained probe to determine a likelihood that the neural network 404 will generate an output that violates a policy, and apply a control action to modify processing of the input 402 by the neural network 404 based on the classification.

In some embodiments, the intermediate activation result 414 can be received from a preselected group of layers of the hidden layers 408, as described with respect to FIG. 1. For example, the classification module 122 of FIG. 1 can be configured to select a layer of the hidden layers 408 from which to obtain the intermediate activation result 414 based on a compression-based criterion, or any other suitable selection approach. In some embodiments, the intermediate activation result 414 can be preprocessed prior to classification using whitening, mean subtraction, decorrelation, normalization, dimensionality reduction, principal component analysis, or any suitable combination thereof, as described with respect to FIG. 1. In some embodiments, the intermediate activation result 414 can be transferred from a first activation space to a second activation space utilizing a transfer-learned model, as described with respect to FIG. 1 and FIG. 5.

In some embodiments, a plurality of intermediate activation results 414 can be generated by a plurality of layers of the hidden layers 408 during processing of the input 402. Each intermediate activation result 414 can correspond to a different layer of the hidden layers 408 and can represent the neural network's internal processing state at a different stage of computation. The plurality of intermediate activation results 414 can be provided to the monitor and control system 120 of FIG. 1 for sequential processing, including windowed aggregation, cumulative sum detection, hidden Markov model regime inference, or any other suitable sequential processing approach, as described with respect to FIG. 1.

FIG. 5 illustrates a block diagram of the classification module 122 configured to process intermediate activation results from an AI system 502 during training, according to some embodiments of the technology described herein. Referring to FIG. 5, the AI system 502 can be an implementation of the AI model(s) 106 of FIG. 1 and/or the Closed AI model(s) 308 of FIG. 3. The AI system 502 includes an execution layer (HW+SW) and a software application, which together generate intermediate activation results during processing.

As shown in FIG. 5, the AI system 502 can be configured to generate a plurality of intermediate activation results, including intermediate activation result 502-1 and intermediate activation result 502-N, where N represents an integer value of 2 or greater. Each intermediate activation result can correspond to a different layer or processing step of the AI system 502. The intermediate activation results 502-1 through 502-N can be depicted as data structures containing numerical values produced by different layers or components of the AI system 502. In some embodiments, the plurality of intermediate activation results can include a number of activation results that is based on a number of layers of the AI system 502.

In some embodiments, the intermediate activation results 502-1 through 502-N can be provided to the classification module 122 for use in training the trained probes. The classification module 122 can correspond to the classification module 122 of FIG. 1 and/or the classification module 324 of FIG. 3. In some embodiments, the classification module 122 can be configured to receive the intermediate activation results from the AI system 502 together with corresponding input-output (I/O) pairs of the AI system 502, enabling the classification module 122 to learn the relationship between intermediate activation results and the outputs they produce.

As shown in FIG. 5, the classification module 122 includes a probe 504-1, which can be configured to process the intermediate activation results. The probe 504-1 can be configured to receive and analyze the intermediate activation result 502-1 directly. In some embodiments, the probe 504-1 can be a software module, software application, binary, library, or any suitable combination thereof. In some embodiments, the probe 504-1 can include a machine learning (ML) model. In some embodiments, the ML model can utilize independent component analysis (ICA), a sparse autoencoder (SAE), a linear classifier, a K-nearest-neighbor classifier, a support vector machine with linear kernels, a naïve Bayes model, a nearest centroid classifier, a decision tree, or any suitable combination thereof. In some embodiments, an ICA, SAE, or other suitable model can be utilized in preprocessing, in inference, or any suitable combination thereof.

In some embodiments, the probe 504-1 can include a linear classifier that is trained based on a plurality of intermediate activation results and a corresponding output of the intermediate result. In some embodiments, each probe can be a linear classifier, a combination of linear classifiers, or any other suitable classifier. In some embodiments, the linear classifier can utilize a radial basis function kernel, a polynomial kernel, a non-linear kernel, or any suitable combination thereof. A linear classifier requires less computation in classification than processing all layers of the AI model, enabling real-time monitoring with minimal latency overhead. In some embodiments, the probe 504-1 can be configured to classify an intermediate activation result into a predefined class.

In some embodiments, the probe 504-1 can be further trained on a sequence of intermediate activation results, such that a second intermediate activation result is generated based on a first intermediate result. This sequence-aware training can enable the probe 504-1 to detect temporal patterns in the intermediate activation results, such as gradual transitions toward policy-violating behavior that are not detectable from a single intermediate activation result alone.

As shown in FIG. 5, the classification module 122 includes an activation space transformation module 506, which can be configured to receive the intermediate activation result 502-N. The activation space transformation module 506 can be configured to transfer an intermediate activation result from a first activation space to a second activation space, where the second activation space is smaller than the first activation space. In some embodiments, transferring an intermediate activation from one space to another can be performed utilizing a transfer-learned model. The activation space transformation module 506 can project the intermediate activation result into a lower-dimensional space that preserves the information relevant to the classification task while discarding information that is not relevant, as described with respect to FIG. 1. A second probe 504-1 can be positioned to receive the transformed output from the activation space transformation module 506 for further processing and classification.

In some embodiments, the activation space transformation module 506 can be configured to implement a provider-side projection that maps each intermediate activation result to a fixed-dimensional vector of substantially lower dimensionality. This can enable monitoring of AI systems whose providers cannot release raw activations, as described with respect to FIG. 3. In some embodiments, the activation space transformation module 506 can be trained using an information-bottleneck objective that maximizes the mutual information between the projected features and the policy-relevant label while minimizing the mutual information between the projected features and protected attributes such as architecture signatures or training-data fingerprints.

In some embodiments, the intermediate activation results 502-1 through 502-N can be preprocessed before classification or before training. Preprocessing can include whitening, mean subtraction, decorrelation, normalization, missing-data imputation, dimensionality reduction, principal component analysis, or any suitable combination thereof, to make the activations more suitable for classification or training. In some embodiments, the intermediate activation result can be transformed to prepare the data for training utilizing any of the preprocessing techniques described above.

In some embodiments, the classification module 122 can be configured to train a plurality of probes. In some embodiments, a plurality of probes can be trained based on different data, such as different intermediate activation results from different layers of the AI system 502. In some embodiments, a plurality of probes, each of a different type, can be trained on the same data, on different data, or any suitable combination thereof, such as some probes trained on the same data and some probes trained on different data.

In some embodiments, a probe can be a trained probe, an untrained probe, a probe trained using supervised learning techniques, a probe trained using unsupervised learning techniques, a probe trained using semi-supervised learning techniques, a probe trained with active learning techniques, a probe trained with human-in-the-loop techniques, or any suitable combination thereof. In some embodiments, the output of one trained probe can be utilized to refine another trained probe. For example, refining can include aiding in data selection, labeling, annotation, performance evaluation, or any suitable combination thereof. This can be utilized to reduce correlations between two trained probes, improving the diversity and robustness of the classification module 122.

In some embodiments, the classification module 122 can be configured to train the probes to be invariant to nuisance variables such as routing state, prompt domain, or model version. For example, the classification module 122 can train a probe using an adversarial-invariance objective in which the probe's internal features are fed both to a label-prediction head and to one or more adversarial heads trained to predict the nuisance variable. The probe can be trained to minimize the label loss while maximizing the adversarial head's loss, yielding features with minimum mutual information with the nuisance variable. This adversarial-invariance training can be particularly useful when the AI system 502 includes a Mixture-of-Experts (MoE) architecture, as described with respect to FIG. 1, where expert specialization can cause a probe trained naively to learn to detect which expert fired rather than the target concept.

In some embodiments, the classification module 122 can be configured to train the probes using supervised subspace projection techniques such as linear discriminant analysis (LDA) or partial least squares (PLS) that identify directions in activation space maximizing separation between classes. LDA can compute a projection that maximizes the ratio of between-class scatter to within-class scatter, providing provably optimal linear class separation under Gaussian assumptions. The projected activations can be fed to a downstream probe for classification. In some embodiments, contrastive principal component analysis (PCA) and kernelized variants of LDA and PLS can be utilized as alternative projection techniques.

In some embodiments, when the AI system 502 is updated or when the AI model is replaced with a new version, the classification module 122 can be configured to align the new projected space onto the old projected space so that existing probes remain valid. The alignment can be performed using paired samples on a shared calibration set, estimating an alignment transform that minimizes the distance between the new and old projected features. This cross-version alignment can preserve continuity of probe validity across model updates without exposing any additional information beyond the calibration samples.

In some embodiments, the classification module 122 can be configured to evaluate the stability of trained probes across model variants by testing the trained probes against intermediate activation results generated by different versions or configurations of the AI model. For example, the classification module 122 can evaluate whether a trained probe that achieves a target classification accuracy on a first version of the AI model maintains comparable accuracy on a second version of the AI model, and flag probes that exhibit significant performance degradation across model variants for retraining.

FIG. 6 illustrates a flowchart of a method 600 for training a software probe for an AI model monitoring system, according to some embodiments of the technology described herein. Referring to FIG. 6, the method 600 can be performed by the classification module 122 of FIG. 1, the classification module 324 of FIG. 3, and/or the classification module 122 of FIG. 5 to train the trained probes utilized for classifying intermediate activation results during runtime operation. In some embodiments, the software probe can implement an ML model and can utilize, for example, ICA, a sparse autoencoder (SAE), a linear classifier, or any suitable combination thereof.

The method 600 begins at a step 602, where the classification module 122 can be configured to receive an intermediate activation result from an AI model. In some embodiments, the intermediate activation result includes a plurality of values which are received from an intermediate output of a neural network, AI model, or other suitable model, as described with respect to FIG. 4.

In some embodiments, the classification module 122 can be configured to receive the intermediate activation result with an identifier of the AI model, a layer of which generated the intermediate activation result. A layer of the AI model includes a plurality of neurons, each neuron configured to process an input and apply a weight to a result of processing the input. In some embodiments, the classification module 122 can be configured to receive a plurality of intermediate activation results. In some embodiments, an order indicator can be received for each intermediate activation result, to indicate an order in which the AI model produced the intermediate activation result. In some embodiments, the plurality of intermediate activation results can include a number of activation results that is based on a number of layers of the AI model.

In some embodiments, the classification module 122 can be configured to select a preselected group of layers of the AI model, and receive an intermediate activation result only from the preselected layers. In some embodiments, the preselected layers can be sequential layers, non-ordered layers, or any suitable combination thereof. For example, the first 4 layers and the last 3 layers of the AI model can be selected from which to receive intermediate activation results. As another example, every Nth layer of the AI model can be selected, or layers can be selected based on a compression-based criterion such as a minimum description length (MDL) criterion, as described with respect to FIG. 1.

At step 604, the classification module 122 can be configured to receive an I/O of the AI model related to the intermediate activation result. In some embodiments, the I/O can include an input of the AI model, an output of the AI model, or any suitable combination thereof. In some embodiments, each I/O can be associated with an intermediate activation result, a plurality of intermediate activation results, or any suitable combination thereof. In some embodiments, the I/O can include a weight value associated with the I/O, indicating the relative importance of the I/O for training purposes. The I/O can enable the classification module 122 to learn the relationship between the intermediate activation result and the output it produces, such that the trained probe can predict whether a given intermediate activation result is likely to lead to an output that violates a policy.

At step 606, the classification module 122 can be configured to train a software probe based on the received intermediate activation result and the received I/O. In some embodiments, the software probe can be a linear classifier, a sparse autoencoder, an independent component analysis (ICA) model, a K-nearest-neighbor classifier, a support vector machine with linear kernels, a naïve Bayes model, a nearest centroid classifier, a decision tree, or any suitable combination thereof. In some embodiments, an ICA, SAE, or other suitable model can be utilized in preprocessing, in inference, or any suitable combination thereof.

In some embodiments, training the software probe can include training a plurality of software probes. In some embodiments, a plurality of software probes can be trained based on different data, such as different intermediate activation results from different layers. In some embodiments, a plurality of software probes, each of a different type, can be trained on the same data, on different data, or any suitable combination thereof, such as some probes trained on the same data and some probes trained on different data.

In some embodiments, the software probe can be trained using supervised learning techniques, unsupervised learning techniques, semi-supervised learning techniques, active learning techniques, human-in-the-loop techniques, or any suitable combination thereof. In some embodiments, the intermediate activation result can be transformed to prepare the data for training utilizing whitening, mean subtraction, decorrelation, normalization, missing-data imputation, dimensionality reduction, principal component analysis, or any suitable combination thereof, to make the activations more suitable for training.

In some embodiments, the output of one trained software probe can be utilized to refine another trained software probe. For example, refining can include aiding in data selection, labeling, annotation, performance evaluation, or any suitable combination thereof. This can be utilized to reduce correlations between two trained software probes, as described with respect to FIG. 5. In some embodiments, the classification module 122 can be configured to train the software probe using an adversarial-invariance objective or a supervised subspace projection technique, as described with respect to FIG. 5.

In some embodiments, the intermediate activation result can be processed to generate a second intermediate activation result. In some embodiments, the second intermediate activation result can be generated by transferring the intermediate activation result from a first activation space to a second activation space, wherein the second activation space is smaller than the first activation space. In some embodiments, transferring an intermediate activation from one space to another can be performed utilizing a transfer-learned model, as described with respect to the activation space transformation module 506 of FIG. 5. The software probe can then be trained on the second intermediate activation result in the second activation space.

At step 608, the classification module 122 can be configured to deploy the trained software probe for the AI model. In some embodiments, deploying the trained software probe can include storing a loss function, storing a weight value, storing a plurality of weight values, or any suitable combination thereof, as a part of the monitor and control system 120 of FIG. 1 and/or the monitor and control system 320 of FIG. 3. In some embodiments, the trained software probe can be deployed as a software module in the classification module 122 of FIG. 1 and/or the classification module 324 of FIG. 3.

In some embodiments, a version number can be associated with the trained software probe. In some embodiments, probes can be trained periodically to account for changes in the AI model's behavior, changes in the policy, or drift in the distribution of inputs. In some embodiments, a portion of software probes can include a first version, and another portion of software probes can include a second version, which is different from the first version. This can enable the classification module 122 to maintain multiple versions of trained probes simultaneously, allowing for gradual rollout of updated probes while maintaining the availability of previously validated probes as a fallback.

In some embodiments, the classification module 122 can be configured to monitor the performance of deployed probes over time and trigger retraining when the classification accuracy falls below a threshold. For example, the monitoring module 126 of FIG. 1 can be configured to periodically evaluate the trained probes against a held-out validation set or against calibration canary inputs, as described with respect to FIG. 1, and trigger retraining when the evaluation indicates degraded performance.

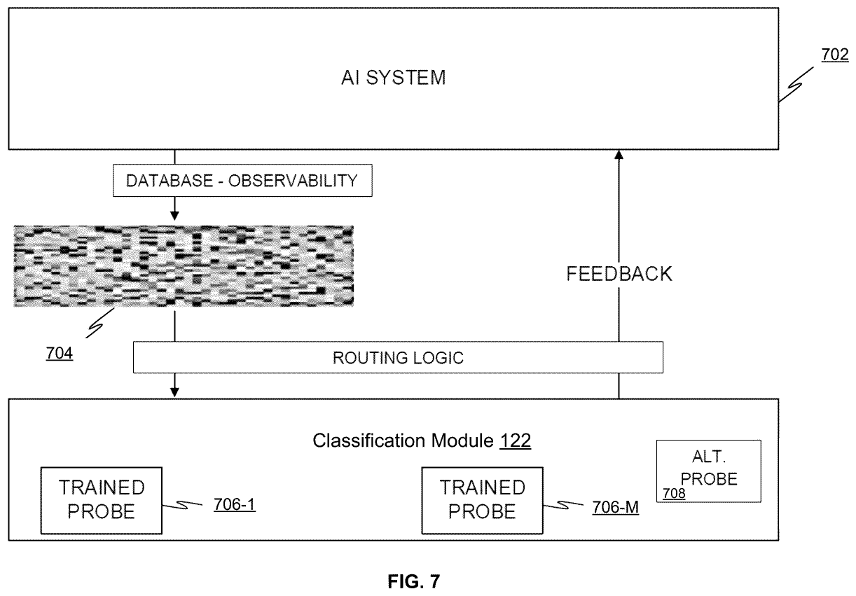

FIG. 7 illustrates a block diagram of a system for monitoring and classifying intermediate activation results from an AI system 702 during runtime operation, according to some embodiments of the technology described herein. Referring to FIG. 7, the system includes the AI system 702, a database for observability, routing logic, and the classification module 122. The AI system 702 can be an implementation of the AI model(s) 106 of FIG. 1 and/or the Closed AI model(s) 308 of FIG. 3. The classification module 122 can correspond to the classification module 122 of FIG. 1 and/or the classification module 324 of FIG. 3.

As shown in FIG. 7, the AI system 702 can be configured to include an AI model, such as a generative AI model. In some embodiments, the generative AI model can be configured to generate text, images, video, or any suitable combination thereof, for example based on an input. In some embodiments, the AI system 702 can include a plurality of AI models. In some embodiments, an AI model can be implemented using a neural network, including a plurality of neurons arranged in layers, as described with respect to FIG. 4.

In some embodiments, the AI system 702 can be configured to process an input by generating a plurality of intermediate activation results during processing operations. The intermediate activation results can be stored in a database labeled as intermediate activation result 704, which captures and maintains records of the intermediate activation results produced by the AI system 702 for subsequent analysis and classification. The database 704 can correspond to the log database 130 of FIG. 1 and/or the log database 330 of FIG. 3. In some embodiments, the database 704 can be configured to store intermediate activation results along with associated metadata, such as the layer from which each intermediate activation result was generated, the input that produced the intermediate activation result, a timestamp, and/or any other suitable metadata.

As shown in FIG. 7, the routing logic component can be configured to receive data from the database 704 and direct the intermediate activation results to appropriate probes within the classification module 122. In some embodiments, the routing logic can be configured to distribute intermediate activation results to various probes based on the type of intermediate activation result, the layer from which the intermediate activation result was generated, the policy being evaluated, the routing state of a Mixture-of-Experts architecture, or any other suitable routing criterion.

In some embodiments, the routing logic can be configured to facilitate parallel or selective processing of the activation data by different probe types, enabling flexible classification approaches where multiple trained probes can analyze the same or different intermediate activation results to generate comprehensive feedback for the AI system 702. For example, the routing logic can be configured to direct an intermediate activation result from a first layer to a first trained probe that specializes in detecting safety violations, and direct an intermediate activation result from a second layer to a second trained probe that specializes in detecting privacy violations, enabling the classification module 122 to evaluate multiple policy dimensions simultaneously.

In some embodiments, intermediate activation results can be received from preselected layers, from randomly selected layers, from a certain number of layers, from a predefined depth of layers, or any suitable combination thereof. In some embodiments, an intermediate activation result can be provided as input for a single trained probe, for a plurality of trained probes, or any suitable combination thereof. In some embodiments, for example where a trained probe includes a linear classifier, an intermediate activation result can be provided to another trained probe based on a result of the classification generated by the linear classifier. This cascading approach can enable the classification module 122 to perform multi-stage classification, where a first probe performs a coarse classification and a second probe performs a finer-grained classification based on the result of the first probe.

As shown in FIG. 7, the classification module 122 includes a plurality of trained probes, including trained probe 706-1 and trained probe 706-M, where M represents an integer value of 2 or greater. The trained probes 706-1 through 706-M can be trained using the methods described with respect to FIG. 5 and FIG. 6. The classification module 122 also includes an alternative probe 708, which can provide additional classification capabilities alongside the trained probes. In some embodiments, the alternative probe 708 can include a probe of a different type than the trained probes 706-1 through 706-M, a probe trained on different data, a probe utilizing a different classification approach such as a distance-based approach, a hidden Markov model approach, a cumulative sum approach, or any other suitable alternative classification mechanism, as described with respect to FIG. 1.

In some embodiments, the classification module 122 can be configured to provide feedback to the AI system 702. In some embodiments, the feedback can be provided based on an output of a trained probe 706-1, on an output of a plurality of trained probes 706-1 through 706-M, on an output of the alternative probe 708, or any suitable combination thereof. In some embodiments, each trained probe 706-1 through 706-M can be associated with a weight, such that a classification provided by each trained probe is weighted when generating feedback from the classification module 122. For example, a trained probe that has demonstrated higher accuracy on a validation set can be assigned a higher weight than a trained probe with lower accuracy, enabling the classification module 122 to generate a more reliable feedback result.

As shown in FIG. 7, a feedback path connects from the classification module 122 back to the AI system 702. The feedback path can be configured to communicate classification results generated by the trained probes 706-1 through 706-M and the alternative probe 708 back to the AI system 702. The feedback can enable the AI system 702 to receive information regarding the classification of its intermediate activation results, which can be used to initiate control actions as described with respect to the control action module 124 of FIG. 1.

In some embodiments, the classification module 122 can be configured to provide the feedback to the AI system 702 to initiate a remediation action, a mitigation action, or any suitable combination thereof. For example, where an intermediate activation result is classified by the classification module 122 as an intermediate activation result having a probability to result in an unwanted output from the AI system 702, the classification module 122 can be configured to generate feedback which, when processed by the AI system 702, causes the AI system 702 to initiate a mitigation action, a remediation action, or any suitable combination thereof.

In some embodiments, generating a mitigation action can include altering an intermediate activation result and providing the altered intermediate activation result back to the AI system 702 for further processing by the AI model. In some embodiments, altering an intermediate activation result can be performed by a generative AI which is configured to generate altered intermediate activation results based on received intermediate activation results. In some embodiments, altering an intermediate activation result can include altering one or more numerical values of the intermediate activation result based on a difference computed between a first set of activations associated with outputs that comply with the policy and a second set of activations associated with outputs that violate the policy, as described with respect to FIG. 1.

In some embodiments, a mitigation action can include configuring the AI system 702 to alter weight values of some neurons of the AI model. In some embodiments, weight values can be altered temporarily, permanently, or any suitable combination thereof. In some embodiments, a plurality of mitigation actions can be initiated. As another example, a second mitigation action can include configuring the AI system 702 to provide another intermediate activation result in response to classifying a first intermediate activation result into a predetermined classification.

In some embodiments, a remediation action can be initiated once the AI system 702 fully processes the input, that is, processes all intermediate activation results to generate the output. In some embodiments, the remediation action can include configuring the AI system 702 to halt sending of the output generated by the AI system 702. For example, where the input is initially received from a device, the AI system 702 can be configured to halt sending the generated output to the device. In some embodiments, a remediation action can include altering a weight of a neuron of the AI model, pruning a neuron of the AI model, halting the AI model from providing the generated output, or any suitable combination thereof.

In some embodiments, a mitigation action can be applied mid-processing, that is, prior to the AI system 702 utilizing the AI model to generate the output. In some embodiments, a remediation action can be applied post-processing, that is, after the AI system 702 utilizes the AI model to generate the output. In some embodiments, the AI system 702 can be configured to process an input, generate an intermediate activation result, provide the intermediate activation result to the classification module 122, and pause execution until feedback is received from the classification module 122. In some embodiments, for example where the intermediate activation result is classified as benign, the AI system 702 can be configured to continue processing the intermediate activation result to eventually generate the output.

In some embodiments, the result of processing an intermediate activation result by one trained probe can be utilized in processing another intermediate activation result, in processing the intermediate activation result with another software probe, or any suitable combination thereof. In some embodiments, processing an intermediate activation result can include generating feedback based on a result of processing the intermediate activation result. In some embodiments, the feedback can be generated based on a plurality of results of processing a plurality of intermediate activation results, a plurality of results of processing a single intermediate activation result utilizing a variety of software probes, or any suitable combination thereof.

In some embodiments, certain software probes can be associated with a weight value, such that an output of a software probe is applied to the weight value when generating the feedback. In some embodiments, the feedback can include a mitigation action, a remediation action, or any suitable combination thereof. In some embodiments, applying a feedback result can include generating a new intermediate activation result, generating an altered intermediate activation result based at least on the received intermediate activation result, or any suitable combination thereof. For example, generating an altered intermediate activation result can include altering values of a received intermediate activation result, replacing certain values while maintaining others.

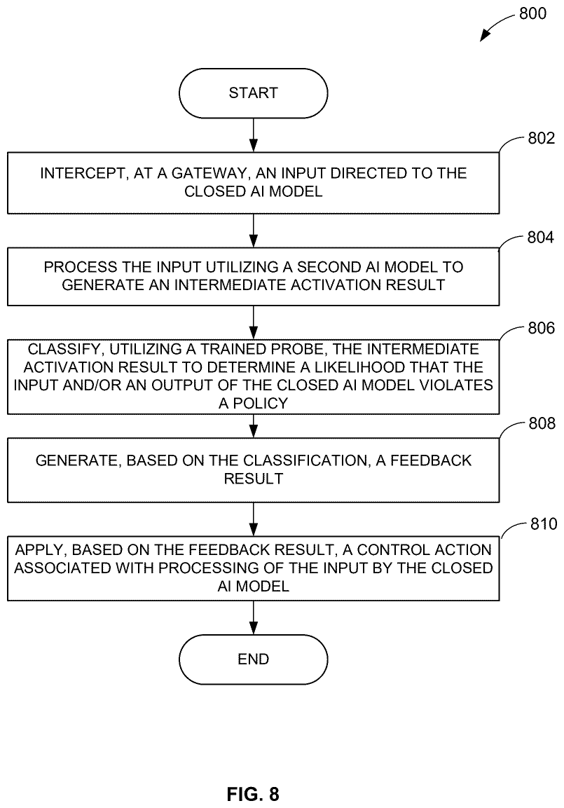

FIG. 8 illustrates a flowchart of a method 800 for monitoring and controlling a closed generative artificial intelligence (AI) model through a gateway, according to some embodiments of the technology described herein. Referring to FIG. 8, the monitor and control system 320 of FIG. 3 can perform the method 800 during run-time operation when the AI model(s) 308 is not directly accessible.

The method 800 begins with a step 802, where the gateway 306 can be configured to intercept an input directed to the closed AI model(s) 308. As described with respect to FIG. 3, the gateway 306 can be positioned between the agent harness 334 and the closed AI model(s) 308, receiving requests from the agent harness 334 prior to transmission to the closed AI model(s) 308. The gateway 306 can serve as a trust boundary for both outgoing traffic directed to the closed AI model(s) 308 and incoming traffic received from the closed AI model(s) 308.

At step 804, the digital twin module 322 can be configured to process the input utilizing a second AI model to generate an intermediate activation result. As described with respect to FIG. 3, the second AI model can be an open-weight model whose internal weights and intermediate activation results are directly accessible during processing. The digital twin module 322 can receive observed context from the gateway 306, normalize the observed context into a unified data model using a context normalizer, and process the normalized context through the second AI model to generate intermediate activation results. The second AI model can process the observed context to generate activations that can be analyzed by the trained probes of the classification module 324, enabling monitoring of the closed AI model(s) 308 without requiring direct access to its internal state.

At step 806, the classification module 324 can be configured to classify the intermediate activation result utilizing a trained probe to determine a likelihood that the input and/or an output of the closed AI model(s) 308 violates a policy. As described with respect to FIG. 3, the trained probe can include a machine learning model trained to discriminate between activations associated with policy-compliant behavior and activations associated with policy-violating behavior.

At step 808, the classification module 324 can be configured to generate a feedback result based on the classification. The feedback result can indicate the likelihood that the input and/or the output of the closed AI model(s) 308 violates the policy and can specify a control action to be applied.

At step 810, the control action module 326 can be configured to apply a control action associated with processing of the input by the closed AI model(s) 308 based on the feedback result. As described with respect to FIG. 3, the control action module 326 can apply the control action through the agent harness 334 and/or the gateway 306 rather than directly to the closed AI model(s) 308. The control action can include modifying the input 304c prior to forwarding the input to the closed AI model(s) 308, modifying the output 310c received from the closed AI model(s) 308 prior to forwarding the output 310b to the agent harness 334, re-prompting the closed AI model(s) 308, or halting transmission of the output 310c entirely. The monitoring module 328 can log the observed context, the classification, and the control action, as described with respect to FIG. 3. The method 800 enables monitoring and control of closed AI models through the gateway 306 without requiring direct access to the internal weights or activations of the closed AI model(s) 308.

FIG. 9 illustrates a block diagram of a computing device 900, according to some embodiments of the technology described herein. Referring to FIG. 9, the computing device 900 can be configured to implement the monitor and control system 120 of FIG. 1, the monitor and control system 320 of FIG. 3, the AI system 502 of FIG. 5, the AI system 702 of FIG. 7, or any suitable combination thereof.

As shown in FIG. 9, the computing device 900 includes a processor 902, a memory 904, and a non-volatile storage 906. The processor 902 can be configured to control writing data to and reading data from the memory 904 and the non-volatile storage 906. To perform any of the functionality described herein, the processor 902 can execute one or more processor-executable instructions stored in one or more non-transitory computer-readable storage media, such as the memory 904, which can serve as non-transitory computer-readable storage media storing processor-executable instructions for execution by the processor 902.

In some embodiments, the processor 902 can be realized as one or more hardware logic components and circuits. For example, illustrative types of hardware logic components can include field programmable gate arrays (FPGAs), application-specific integrated circuits (ASICs), application-specific standard products (ASSPs), system-on-a-chip systems (SOCs), graphics processing units (GPUs), tensor processing units (TPUs), artificial intelligence (AI) accelerators, general-purpose microprocessors, microcontrollers, digital signal processors (DSPs), or any other suitable hardware logic components that are configured to perform calculations or other manipulations of information.

In some embodiments, the memory 904 can be a volatile memory (e.g., random access memory), a non-volatile memory (e.g., read only memory, flash memory), or any suitable combination thereof. In some embodiments, the memory 904 can be an on-chip memory, an off-chip memory, or any suitable combination thereof. In some embodiments, the memory 904 can be a scratch-pad memory for the processor 902.

In some embodiments, software for implementing one or more embodiments disclosed herein can be stored in the non-volatile storage 906, in the memory 904, or any suitable combination thereof. Software can be construed broadly to mean any type of instructions, whether referred to as software, firmware, middleware, microcode, hardware description language, or otherwise. Instructions can include code in source code format, binary code format, executable code format, or any other suitable format of code. The instructions, when executed by the processor 902, can cause the processor 902 to perform the various processes described herein.

In some embodiments, the non-volatile storage 906 can be a magnetic storage, an optical storage, a solid-state storage, or any suitable combination thereof. The non-volatile storage 906 can be realized as a flash memory, a hard-disk drive, another memory technology, various combinations thereof, or any other medium which can be used to store the desired information. In some embodiments, the non-volatile storage 906 can be configured to store trained software probes, weight values, loss functions, version information, logged intermediate activation results, classification results, feedback results, control actions, and/or any other suitable data utilized by the monitor and control system 120 of FIG. 1 and/or the monitor and control system 320 of FIG. 3.

In some embodiments, the computing device 900 can include a network interface (not shown) configured to provide the computing device 900 with communication capabilities. The network interface can be configured to enable communication with, for example, the AI system 502 of FIG. 5, the AI system 702 of FIG. 7, the business application 102 of FIG. 1, the business application 302 of FIG. 3, the external event management system(s) 128 of FIG. 1, the external event management system(s) 332 of FIG. 3, or any other suitable external component.

It should be appreciated that the embodiments described herein are not limited to the specific architecture illustrated in FIG. 9, and other architectures can be equally used without departing from the scope of the disclosed embodiments. In some embodiments, the monitor and control system 120 of FIG. 1, the monitor and control system 320 of FIG. 3, the AI system 502 of FIG. 5, the AI system 702 of FIG. 7, or any suitable combination thereof, can be implemented with the architecture illustrated in FIG. 9. In other embodiments, other architectures can be equally used without departing from the scope of the disclosed embodiments.

In some embodiments, a system of one or more computers can be configured to perform particular operations or actions by virtue of having software, firmware, hardware, or any suitable combination thereof installed on the system that in operation causes or cause the system to perform the actions. In some embodiments, one or more computer programs can be configured to perform particular operations or actions by virtue of including instructions that, when executed by data processing apparatus, cause the apparatus to perform the actions.

The terms “program” or “software” are used herein in a generic sense to refer to any type of computer code or set of processor-executable instructions that can be employed to program a computer or other processor to implement various aspects of embodiments as discussed above. Additionally, one or more computer programs that when executed perform methods of the disclosure provided herein need not reside on a single computer or processor, but can be distributed in a modular fashion among different computers or processors to implement various aspects of the disclosure provided herein.

Processor-executable instructions can be in many forms, such as program modules, executed by one or more computers or other devices. Generally, program modules include routines, programs, objects, components, data structures, or other suitable constructs that perform tasks or implement abstract data types. The functionality of the program modules can be combined or distributed as desired in various embodiments.

The foregoing description of implementations provides illustration and description but is not intended to be exhaustive or to limit the implementations to the precise form disclosed. Modifications and variations are possible in light of the above teachings or may be acquired from practice of the implementations. In other implementations the methods depicted in these figures may include fewer operations, different operations, differently ordered operations, and/or additional operations. Further, non-dependent blocks may be performed in parallel.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A computer-implemented method for monitoring and controlling a generative artificial intelligence (AI) model, comprising:
selecting a layer of the AI model from which to obtain an intermediate activation result;
receiving the intermediate activation result generated by the selected layer during processing of an input;
classifying, utilizing a trained probe, the intermediate activation result to determine a likelihood that the input and/or an output of the AI model violates a policy;
generating, based on the classification, a feedback result; and
modifying processing of the input by the AI model by applying a control action based on the feedback result.

2. The method of claim 1, wherein the AI model pauses execution after generating the intermediate activation result and resumes execution after receiving the feedback result, such that the control action affects generation of the output.

3. The method of claim 2, wherein the control action comprises:
generating an altered intermediate activation result by altering one or more numerical values of the intermediate activation result based on activations associated with outputs that comply with the policy and activations associated with outputs that violate the policy; and
providing the altered intermediate activation result to the AI model for continued processing.

4. The method of claim 1, wherein the control action comprises halting transmission of the output to a device that originated the input.

5. The method of claim 1, wherein the control action comprises altering a weight value associated with at least one neuron of the AI model.

6. The method of claim 1, wherein the control action comprises pruning at least one neuron of the AI model.

7. The method of claim 1, wherein the trained probe comprises a machine learning model.

8. The method of claim 7, wherein the machine learning model comprises at least one of: a linear classifier, a sparse autoencoder, an independent component analysis model, a K-nearest-neighbor classifier, a support vector machine with linear kernels, a naïve Bayes model, a nearest centroid classifier, or a decision tree.

9. The method of claim 1, further comprising:
utilizing a plurality of trained probes to classify the intermediate activation result, wherein each trained probe of the plurality is associated with a weight; and
generating the feedback result by combining outputs of the plurality of trained probes according to their respective weights.

10. The method of claim 1, wherein selecting the layer comprises selecting a preselected group of layers of the AI model from which to receive intermediate activation results.

11. The method of claim 10, wherein the preselected group comprises a first set of sequential layers from a beginning of the AI model and a second set of sequential layers from an end of the AI model.

12. The method of claim 1, further comprising preprocessing the intermediate activation result prior to the classifying, wherein preprocessing comprises at least one of: whitening, mean subtraction, decorrelation, normalization, missing-data imputation, dimensionality reduction, or principal component analysis.

13. The method of claim 1, further comprising:
transferring the intermediate activation result from a first activation space to a second activation space utilizing a model that learns a transfer mapping between the first activation space and the second activation space, wherein the second activation space is smaller than the first activation space; and
classifying a second intermediate activation result generated in the second activation space.

14. The method of claim 1, wherein classifying the intermediate activation result further comprises receiving, as an auxiliary input to the trained probe, a routing state indicating a subset of expert sub-networks selected to process the input.

15. The method of claim 1, further comprising:
receiving a plurality of intermediate activation results over a sequence of processing steps; and
aggregating outputs of the trained probe over a sliding window of the sequence to generate an aggregated result, wherein generating the feedback result is based on the aggregated result.

16. The method of claim 15, further comprising:
accumulating a cumulative sum of classification scores generated by the trained probe over the sequence of processing steps; and
generating the feedback result when the cumulative sum exceeds a threshold.

17. The method of claim 1, wherein classifying comprises:
computing a distance between the intermediate activation result and a mean of a distribution of activations associated with outputs that comply with the policy, the distance accounting for a covariance of the distribution; and
determining the likelihood based on the distance.

18. The method of claim 15, further comprising:
maintaining a hidden Markov model with a plurality of latent states representing regimes of behavior of the AI model;
inferring, from the outputs of the trained probe over the sequence, a posterior distribution over the latent states; and
generating the feedback result based on the posterior distribution.

19. The method of claim 1, further comprising logging the intermediate activation result, the classification, and the control action.

20. The method of claim 19, further comprising retraining the trained probe based on the logged intermediate activation result and the logged classification.

21. A system for monitoring and controlling a generative artificial intelligence (AI) model, comprising:
a processor; and
a memory storing instructions that, when executed by the processor, cause the processor to:
select a layer of the AI model from which to obtain an intermediate activation result;
receive the intermediate activation result generated by the selected layer during processing of an input;
classify, utilizing a trained probe, the intermediate activation result to determine a likelihood that the input and/or an output of the AI model violates a policy;
generate, based on the classification, a feedback result; and
modify processing of the input by the AI model by applying a control action based on the feedback result.

22. The system of claim 21, wherein the AI model pauses execution after generating the intermediate activation result and resumes execution after receiving the feedback result, such that the control action affects generation of the output.

23. A non-transitory computer-readable medium storing instructions that, when executed by one or more processors, cause the one or more processors to:
select a layer of a generative artificial intelligence (AI) model from which to obtain an intermediate activation result;
receive the intermediate activation result generated by the selected layer during processing of an input;
classify, utilizing a trained probe, the intermediate activation result to determine a likelihood that the input and/or an output of the AI model violates a policy;
generate, based on the classification, a feedback result; and
modify processing of the input by the AI model by applying a control action based on the feedback result.

24. The non-transitory computer-readable medium of claim 23, wherein the AI model pauses execution after generating the intermediate activation result and resumes execution after receiving the feedback result, such that the control action affects generation of the output.

25. The method of claim 1, wherein the AI model operates within an agent harness, and wherein receiving the intermediate activation result comprises receiving the intermediate activation result generated during the agent harness processing the input and/or the output by the AI model.

26. The method of claim 25, further comprising:
classifying, utilizing the trained probe, a second intermediate activation result generated after the agent harness modifies a context associated with the input to determine whether the policy is preserved in the modified context.
